(19) United States
(12) Patent Application Publication
(10) Pub. No.: US 2011/0293998 A1
(43) Pub. Date: Dec. 1, 2011

(54) BATTERY UNIT

(75) Inventors: Bunya Sato, Saitama (JP); Tatsuya Adachi, Fukushima (JP); Hiroshi Kano, Fukushima (JP); Tsutomu Aoyama, Fukushima (JP); Tsuyoshi Toukairin, Fukushima (JP); Akira Sanpei, Fukushima (JP)

(73) Assignee: SONY CORPORATION, Tokyo (JP)

(21) Appl. No.: 13/113,611

(22) Filed: May 23, 2011

(30) Foreign Application Priority Data
May 31, 2010 (JP) P2010-124938

(51) Int. Cl. H01M 2/20; H01R 13/02; H01M 2/10

(52) U.S. Cl. 429/159; 439/890

(57) ABSTRACT

In one example embodiment, a battery unit includes a battery case, and a plurality of battery blocks stored in the battery case. The plurality of battery blocks are electrically connected together in series. In one example embodiment, a first plurality of the battery blocks form a first column and are arranged in a side-to-side configuration. In one example embodiment, a second plurality of the battery blocks form a second column and are arranged in an end-to-end configuration which is different from the side-to-side configuration.

### CROSS REFERENCES TO RELATED APPLICATIONS

The present application claims priority to Japanese Patent Application No. JP 2010-124938, filed in the Japanese Patent Office on May 31, 2010 the entire contents of which is being incorporated herein by reference.

### BACKGROUND

The present application relates to a battery unit, specifically, a battery unit that includes a plurality of battery blocks.

In recent years, the application of a secondary battery such as a lithium ion battery which is used as an electric power storing storage battery combined with a storage battery of a motor vehicle such as a hybrid motor vehicle and a battery motor vehicle, and a new energy system such as a solar battery and a wind power generation has rapidly expanded.

These storage batteries are generally configured so that a plurality of unit batteries is connected in multi-series and multi parallel with each other to form a battery block and the battery block is received in a receiving case. In Japanese Unexamined Patent Application Publication No. 2009-289429, there is a description of a storage battery in which a battery block is constituted by connecting between the respective terminals of adjoining unit batteries using a plurality of connectors (bus bars).

However, in the storage battery of Japanese Unexamined Patent Application Publication No. 2009-289429, since a portion between the respective terminals of the adjoining unit storage batteries is connected using a plurality of connectors, a connection portion and the number of connection paths may increase and a connection electric resistance may become larger.

Thus, it is desirable to provide a battery unit that can simplify a connection portion and a connection path to reduce the connection electric resistance.

### SUMMARY

In one example embodiment, a battery unit includes a battery case, and a plurality of battery blocks stored in the battery case, the plurality of battery blocks electrically connected in series, wherein: (a) a first plurality of the battery blocks form a first column, the first plurality of the battery blocks in the first column being arranged in a side-to-side configuration; (b) a second plurality of the battery blocks form a second column, the second plurality of the battery blocks in the second column being arranged in an end-to-end configuration which is different from the side-to-side configuration; and (c) the first column is electrically connected in series to the second column.

In one example embodiment, each of the plurality of battery blocks stored in the battery case include: (a) a plurality of batteries connected in parallel, each battery having a positive terminal end and a negative terminal end; (b) a positive terminal battery holder for securing the positive terminal end of each of the plurality of batteries such that the plurality of batteries are arranged in a predetermined configuration; (c) a negative terminal battery holder for securing the negative terminal end of each of the plurality of batteries such that the plurality of batteries are arranged in the predetermined configuration; (d) a positive pole metallic plate including positive terminal contact portions which are electrically connected to the positive terminal ends of the plurality of batteries, the positive terminal contact portions being arranged in predetermined positions based on the plurality of batteries being arranged in the predetermined configuration; and (e) a negative pole metallic plate including negative terminal contact portions which are electrically connected to the negative terminal ends of the plurality of batteries, the negative terminal contact portions being arranged in predetermined positions based on the plurality of batteries being arranged in the predetermined configuration.

In one example embodiment, the battery case includes at least one battery block restriction portion which restricts a position of at least one of the plurality of battery blocks stored in the battery case.

In one example embodiment, the battery block restriction portion restricts a position of a first one of the plurality of battery blocks relative to a position of a second one of the plurality of battery blocks such that a positive pole connection portion of the positive pole metallic plate of the first one of the plurality of battery blocks is positionally fixed relative to a negative pole connection portion of the negative pole metallic plate of the second one of the plurality of battery blocks.

In one example embodiment, the battery case includes at least one battery block restriction portion which restricts a position of at least one of the plurality of battery blocks stored in the battery case.

In one example embodiment, the plurality of battery blocks stored in the battery case are positioned within the battery case such that the plurality of battery blocks form approximately an M-shape.

In one example embodiment, a current flows through the plurality of battery blocks stored in the battery case, the current flow following approximately an M-shaped path which is governed by the approximate M-shape formed by the positioning of the plurality of battery blocks stored in the battery case.

In one example embodiment, an electrically conductive terminal for electrically connecting a plurality of batteries in parallel includes a base plate which includes; (a) a terminal connection portion oriented in a first plane, the terminal connection portion including a plurality of battery terminal contact portions arranged in a plurality of columns such that the plurality of batteries are connected in parallel; (b) a lead-out portion oriented in a second plane which is different from the first plane; and (c) a connection portion oriented in a third plane which is different from the second plane.

In one example embodiment, each of the battery terminal contact portions include at least one convex shape portion.

In one example embodiment, the lead-out portion includes a first portion and a second portion, the first portion being oriented substantially perpendicular to the terminal connection portion and the second portion being oriented substantially parallel to the terminal connection portion.

In one example embodiment, a battery block includes: a plurality of batteries connected in parallel, each battery having a positive terminal end and a negative terminal end; a positive terminal battery holder for securing the positive terminal end of each of the plurality of batteries such that the plurality of batteries are arranged in a predetermined configuration; a negative terminal battery holder for securing the negative terminal end of each of the plurality of batteries such that the plurality of batteries are arranged in the predetermined configuration; a positive pole metallic plate including positive terminal contact portions which are electrically connected to the positive terminal ends of the plurality of batteries, the positive terminal contact portions being arranged in predetermined positions based on the plurality of batteries being arranged in the predetermined configuration; and a negative pole metallic plate including negative terminal contact portions which are electrically connected to the negative terminal ends of the plurality of batteries, the negative terminal contact portions being arranged in predetermined positions based on the plurality of batteries being arranged in the predetermined configuration.

In one example embodiment, the positive pole metallic plate and the negative pole metallic plate have a different shape relative to one another.

In one example embodiment, the positive terminal battery holder and the negative terminal battery holder have a different shape relative to one another.

In one example embodiment, the positive terminal battery holder and the negative terminal battery holder each include a plurality of voids such that the negative pole metallic plate contacts the negative terminal end of each of the plurality of batteries and such that the positive pole metallic plate contacts the positive terminal end of each of the plurality of batteries.

In one example embodiment, the positive terminal battery holder and the negative terminal battery holder each include a plurality of fixing portions which fix the positions of the plurality of batteries relative to one another.

In one example embodiment, the positive terminal battery holder and the negative terminal battery holder each include a metallic plate disposition surface, the metallic plate disposition surface on the positive terminal battery holder being configured to accommodate the positive pole metallic plate and the metallic plate disposition surface on the negative terminal battery holder being configured to accommodate the negative pole metallic plate.

In one example embodiment, a battery unit includes: a battery case; and a plurality of battery blocks stored in the battery case, the plurality of battery blocks electrically connected together, wherein: (a) a connection metal electrically connects together adjoining battery blocks of the plurality of battery blocks; (b) each of the battery blocks include: (i) a positive pole plate having a lead out portion which is disposed on a first side surface of the battery block; and (ii) a negative pole plate having a lead out portion which is disposed on a second side surface of the battery block; and (c) the positive pole plate lead out portion and the negative pole plate lead out portion of adjoining battery blocks are electrically connected together by the connection metal.

As mentioned above, according to one embodiment, it is possible to simplify the connection portion and the connection path, thereby reducing the connection electric resistance.

Additional features and advantages are described herein, and will be apparent from the following Detailed Description and the figures.

### BRIEF DESCRIPTION OF THE FIGURES

FIG. 1 is a perspective view that shows an example of an overview of a battery unit according to an embodiment of the present application.

FIG. 2 is an exploded perspective view that shows an example of a configuration of a battery unit according to an embodiment of the present application.

FIGS. 3A and 3B are perspective views that show an example of a configuration of an exterior lower case and an exterior upper case.

FIGS. 4A and 4B are perspective views that show an example of a configuration of a battery block.

FIGS. 5A and 5B are perspective views of a battery block in a state in which a positive pole metallic plate and a negative pole metallic plate are removed.

FIGS. 6A and 6B are perspective views that show an example of a configuration of a battery holder.

FIG. 7 is a cross-sectional view that shows an example of a configuration of a battery block.

FIG. 8A is a perspective view of a battery block in a state in which a positive pole metallic plate and a negative pole metallic plate are removed.

FIG. 8B is a side view that shows the battery block shown in FIG. 8A from a direction of an arrow VIIIB.

FIG. 8C is a side view that shows the battery block shown in FIG. 8A from a direction of an arrow VIIIC.

FIG. 9A is a side view of a battery block in a state in which a battery holder is removed.

FIG. 9B is a perspective view that shows an example of a configuration of a positive pole metallic plate.

FIG. 9C is a perspective view that shows an example of a configuration of a negative pole metallic plate.

FIG. 10A is a perspective view that indicates a part of a terminal connection portion of a negative pole metallic plate in an enlarged manner.

FIG. 10B is a side view that shows the negative pole metallic plate shown in FIG. 10A from a direction shown by an arrow XB.

FIG. 11 is a perspective view that shows an example of an arrangement of a battery block restriction portion.

FIG. 12A is a perspective view that shows an overview of a battery block accommodated in a battery block restriction portion.

FIG. 12B is a perspective view that shows an example of a configuration of a battery block restriction portion.

FIG. 12C is a perspective view that shows a modified example of a battery block restriction portion.

FIGS. 13A to 13C are diagrams that show an example of a configuration of a battery block with a shock absorbing material disposed thereon.

FIG. 14A is a perspective view when viewing a negative pole terminal surface side of a battery block from a lower part.

FIG. 14B is a perspective view at the time of viewing a positive pole terminal surface side of a battery block from an upper part.

FIG. 14C is a perspective view at the time of viewing a negative pole terminal surface side of a battery block from an upper part.

FIG. 15A is a perspective view at the time of viewing an accommodation portion of a battery block restriction portion from a lower part.

FIG. 15B is a perspective view at the time of viewing an accommodation portion of a battery block restriction portion from an upper part.

FIG. 16A is a perspective view that shows a correct accommodation direction of a battery block relative to an accommodation portion.

FIGS. 16B to 16D are perspective views that show incorrect accommodation directions of a battery block relative to an accommodation portion.

FIG. 17A is a perspective view at the time of viewing a negative pole terminal surface side of a battery block from a lower part.

FIG. 17B is a perspective view at the time of viewing a positive pole terminal surface side of a battery block from an upper part.

FIG. 17C is a perspective view at the time of viewing a negative pole terminal surface side of a battery block from an upper part.

FIG. 18A is a perspective view at the time of viewing an accommodation portion of a battery block restriction portion from a lower part.

FIG. 18B is a perspective view at the time of viewing an accommodation portion of a battery block restriction portion from an upper part.

FIG. 19A is a perspective view that shows a correct accommodation direction of a battery block relative to an accommodation portion.

FIGS. 19B to 19D are perspective views that show incorrect accommodation directions of a battery block relative to an accommodation portion.

FIG. 20A is a perspective view at the time of viewing a negative pole terminal surface side of a battery block from a lower part.

FIG. 20B is a perspective view at the time of viewing a positive pole terminal surface side of a battery block from an oblique upper part of a connection portion.

FIG. 20C is a perspective view at the time of viewing a positive pole terminal surface side of a battery block from an oblique upper part of a connection portion.

FIG. 21A is a perspective view at the time of viewing an accommodation portion of a battery block restriction portion from a lower part.

FIG. 21B is a perspective view at the time of viewing an accommodation portion of a battery block restriction portion from an upper part.

FIG. 22A is a perspective view that shows a correct accommodation direction of a battery block relative to an accommodation portion.

FIGS. 22B and 22C are perspective views that show incorrect accommodation directions of a battery block relative to an accommodation portion.

FIG. 22D is a perspective view that shows a correct accommodation direction of a battery block relative to an accommodation portion.

FIG. 23A is a perspective view at the time of viewing a negative pole terminal surface side of a battery block from a lower part.

FIG. 23B is a perspective view at the time of viewing a positive pole terminal surface side of a battery block from an upper part.

FIG. 23C is a perspective view at the time of viewing a negative pole terminal surface side of a battery block from an upper part.

FIG. 24A is a perspective view at the time of viewing an accommodation portion of a battery block restriction portion from a lower part.

FIG. 24B is a perspective view at the time of viewing an accommodation portion of a battery block restriction portion from an upper part.

FIG. 25A is a perspective view that shows a correct accommodation direction of a battery block relative to an accommodation portion.

FIGS. 25B to 25D are perspective views that show incorrect accommodation directions of a battery block relative to an accommodation portion.

FIG. 26 is plan view that shows an example of connection configurations of a plurality of battery blocks accommodated in an exterior lower case.

FIG. 27 is a perspective view that shows an example of connection configurations of a plurality of battery blocks.

FIG. 28A is a schematic line view that shows a structure of a safety valve of a common state.

FIG. 28B is a schematic line view that shows a structure of a safety valve of a shut-off state.

FIG. 29A is a plan view that shows a structure of a safety valve of a common state.

FIG. 29B is a plan view that shows a structure of a safety valve of a shut-off state.

FIG. 30 is a perspective view that shows an example of an arrangement configuration of a connection metallic plate.

FIGS. 31A to 31E are enlarged views of connection metallic plates.

FIG. 32A is a perspective view that shows a battery block connected with a connection metallic plate.

FIG. 32B is an exploded view that shows a configuration member used in the connection with the connection metallic plate.

FIG. 33 is a circuit diagram that shows a connection circuit diagram of a battery unit according to an embodiment of the present application.

FIG. 34 is a circuit diagram that shows a first configuration example of a battery unit according to an embodiment of the present application.

FIGS. 35A to 35C are diagrams that show states of a switch S1 and another switch S2 at the time of controlling a charge and a discharge, FIG. 35A is a diagram that shows a connection state of a switch S1 and the other switch S2, FIG. 35B is a diagram that shows an open state of a switch S2 and a connection state of a switch S1, and FIG. 35C is a diagram that shows an open state of a switch S1 and a connection state of the other switch S2.

FIG. 36 is a state transition diagram of a battery unit according to an embodiment of the present application.

FIG. 37 is a circuit diagram that shows a second configuration example of a battery unit according to an embodiment of the present application.

FIG. 38 is a circuit diagram that shows a third configuration example of a battery unit according to an embodiment of the present application.

FIG. 39 is an exploded perspective view that shows a modified example of a battery unit according to an embodiment of the present application.

FIGS. 40A and 40B are perspective views that show modified examples of a battery block.

FIGS. 41A and 41B are perspective views that show modified examples of a battery blocks.

FIGS. 42A and 42B are perspective views that show modified examples of a battery block.

### DETAILED DESCRIPTION

Embodiments of the present application will be described below in detail with reference to the drawings.

Configuration of Battery Unit

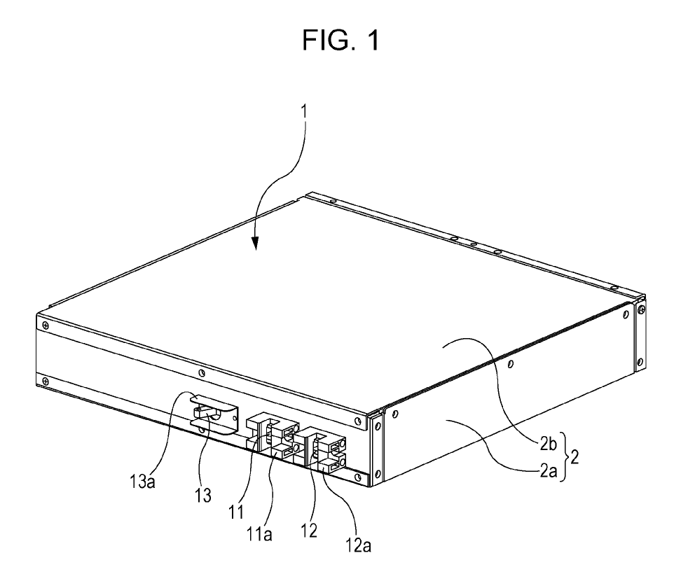

FIG. 1 is a perspective view that shows an example of an overview of a battery unit according to an embodiment of the present application. On the front surface of a battery unit 1, an external positive pole terminal 11 and an external negative pole terminal 12 for performing the charging and the discharging with respect to the battery unit 1 are adjacently provided. On both sides of the external positive pole terminal 11, short preventing walls 11a for preventing a short between the terminals are provided. On both sides of the external negative pole terminal 12, short preventing walls 12a for preventing the short between the terminals are provided. Furthermore, on both sides of the external positive pole terminal 11, short preventing walls 11a for preventing a short between the terminals are provided. Moreover, on the front surface of the battery unit 1, a current breaker 13 is provided. By providing the current breaker 13 in this manner, the stability of the battery unit can be improved. A malfunction preventing portion 13a is provided around the current breaker 13. For example, when an object larger than the malfunction preventing portion 13a is pressed to the current breaker 13, the object is maintained by the malfunction preventing portion 13a, and the object hardly contacts the current breaker 13. For example, a man consciously operates a lever of the current breaker 13 by hand, whereby it is possible to switch over a switch of the current breaker 13. By providing the malfunction preventing portion 13a in this manner, it is possible to prevent the malfunction of the current breaker 13 and improve the stability.

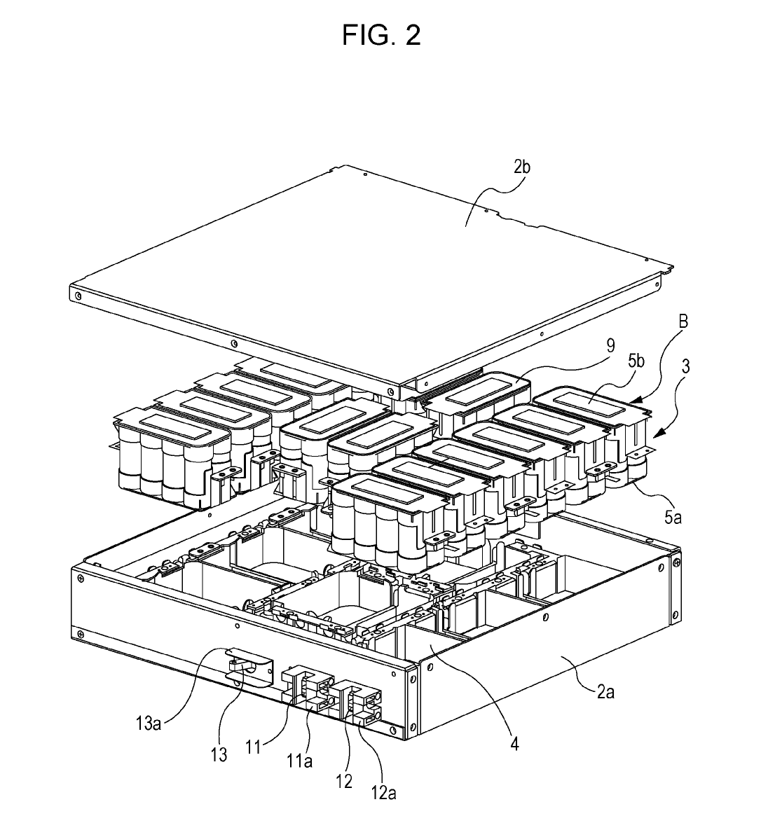

FIG. 2 is an exploded perspective view that shows an example of a configuration of a battery unit according to an embodiment of the present application. Herein, an exterior case 2 includes an exterior lower case 2a and an exterior upper case 2b. The battery unit 1 includes an exterior case 2 as a case, a battery module 3 accommodated in the exterior case 2, a plurality of battery block restriction portions 4 for restricting positions in the case 2 of a battery block B constituting the battery module 3, a shock absorbing material 5a and a shock absorbing material 5b that are disposed in a lower surface and an upper surface of the battery block B, respectively. Furthermore, in view of the insulating property, it is desirable to provide insulation paper 9 in the upper surface and/or the lower surface of the battery block B. The exterior case 2 includes an exterior lower case 2a for accommodating the battery module 3, and an exterior upper case 2b covering the exterior lower case 2a with the plurality of battery blocks B accommodated therein. The battery module 3 is formed by connecting the plurality of battery blocks B in series or in parallel. A terminal end portion of the battery module 3 is connected to the current breaker 13. The exterior lower case 2a has a configuration which enables the battery block B to be attached and detached by the battery block restriction portion 4. By such a configuration, the assembly operation efficiency of the battery unit 1 can be improved. Furthermore, at the time of the breakdown of the battery block B, the battery block B can be easily replaced.

Exterior Case

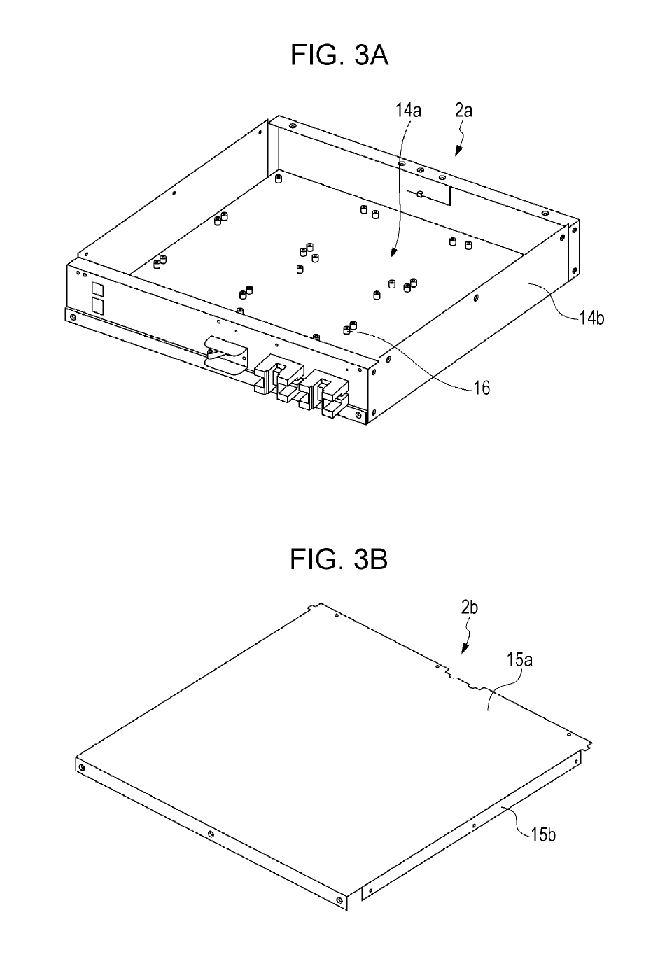

FIGS. 3A and 3B are perspective views that show an example of a configuration of the exterior lower case and the exterior upper case. The exterior lower case 2a includes a rectangular bottom surface portion 14a and a wall portion 14b erected around the bottom surface portion 14a. The exterior upper case 2b includes a rectangular upper surface portion 15a and a wall portion 15b erected around the upper surface portion 15a. The wall portion 15b of the exterior upper case 2b is set to be lower than the wall portion 14b of the exterior lower case 2a, and the wall portion 15b of the exterior upper case 2b is fitted into the inside of the upper portion of the wall portion 14b of the exterior lower case 2a, whereby the case 2 is formed. On the inside surface of the bottom surface portion 14a of the exterior lower case 2a, a fixing portion 16 such as a screw hole for fixing the battery block restriction portion 4 is provided. The wall portion 14b of the exterior lower case 2a and the wall portion 15b of the exterior upper case 2b are fixed by inserting and rotating the screws into the hole portion of the wall portion 14b and the hole portion of the wall portion 15b to perform screw fastening. Even on the side surface facing the wall portion 14b of the exterior lower case 2a, the screw fastening is similarly performed. The exterior lower case 2a and the exterior upper case 2b are combined and fixed to each other.

As materials of the exterior lower case 2a and the exterior upper case 2b, it is desirable to use materials having high heat conductivity and a high emissivity. An excellent case radiant heat property can be obtained, and a temperature increase in the case can be suppressed. Furthermore, by having the excellent case radiant heat property, an opening portion of the case 2 can be minimized or eliminated and a high anti-dust and anti-dropping property can be realized. Furthermore, the surfaces of the exterior lower case 2a and the exterior upper case 2b may have concave and convex shapes. When the surfaces are concave and convex shapes, since an area contacting the air is further enlarged, the cooling performance can be enhanced. On the surfaces of the inside or the outside of the exterior lower case 2a and the exterior upper case 2b, a paint having an electrical insulating property may be applied. On the surfaces of the inside or the outside of the exterior lower case 2a and the exterior upper case 2b, a thin insulation sheet having an electrical insulating property may be bonded. The surfaces of the exterior lower case 2a and the exterior upper case 2b have the electrical insulating property, whereby it is possible to prevent an abnormal electrical connection between the exterior case 2 and the inner components. Furthermore, a metal portion of the case is covered with the paint or the insulation sheet, whereby the metal does not directly come into contact with the air, which can prevent an occurrence of rust due to the oxidation of the metal. For example, the materials of the exterior lower case 2a and the exterior upper case 2b are aluminum, aluminum alloy, copper, or copper alloy. For example, the plate thickness of the exterior lower case 2a and the exterior upper case 2b is roughly equal to or greater than 1 mm.

Battery Block

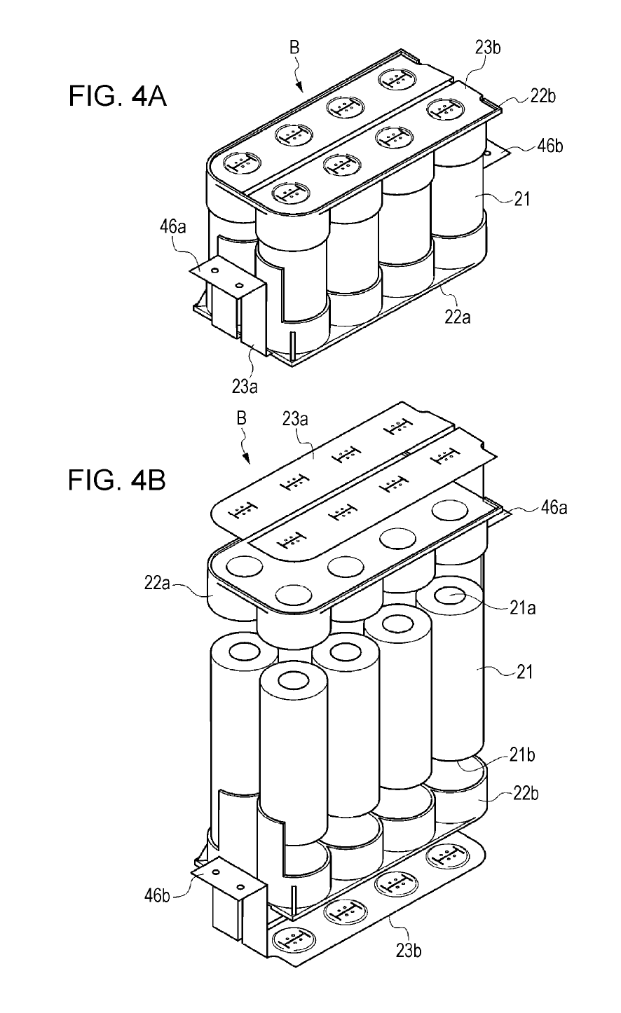

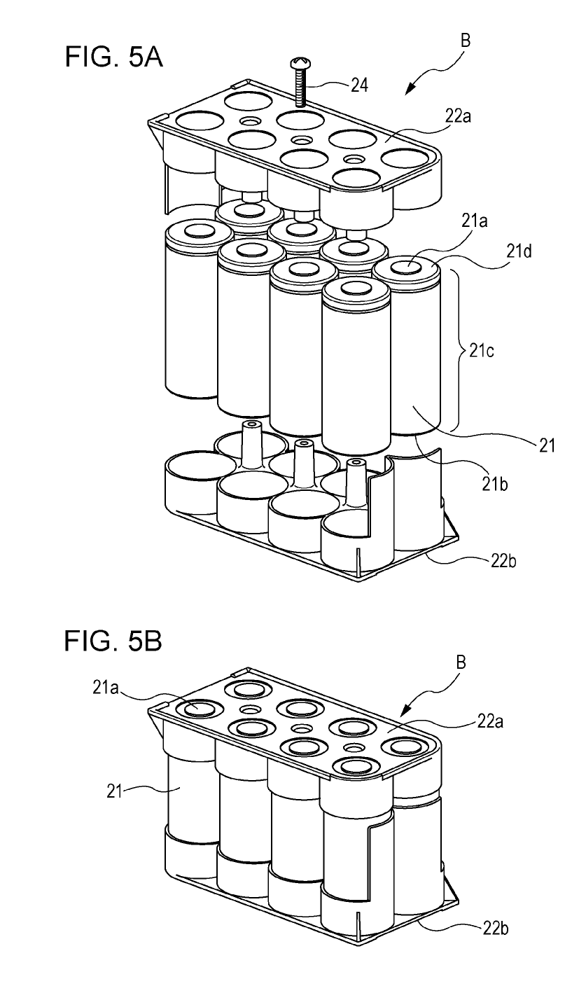

FIGS. 4A and 4B are perspective views that show an example of a configuration of a battery block. FIGS. 5A and 5B are perspective views of a battery block in a state in which a positive pole metallic plate or a negative pole metallic plate is removed. The battery block B includes a plurality of batteries 21, a battery holder 22a, a battery holder 22b, a positive pole metallic plate 23a, and a negative pole metallic plate 23b, and the battery blocks B are assembled from these components.

Both end portions of the plurality of batteries 21 are fixed by the battery holder 22a and the battery holder 22b, respectively, so that the positive pole terminal portions of the plurality of batteries 21 are arranged in the same direction and form one or a plurality of rows. Specifically, an end portion becoming a side of the positive pole terminal portions 21a of the plurality of batteries 21 is fixed by the battery holder 22a, and the other end portion becoming a side of the negative pole terminal portion 21b is fixed by the battery holder 22b. In a state in which both end portions of the plurality of batteries 21 are fixed, the battery holder 22a and the battery holder 22b are fastened and fixed, for example, by a screw 24 or the like.

The positive pole metallic plate 23a is arranged on the battery holder 22a fixing an end portion of the battery 21, and the positive pole terminals 21a of the plurality of batteries 21 and the positive pole metallic plate 23a are electrically connected to each other. On the other hand, the negative pole metallic plate 23b is arranged on the battery holder 22b fixing the other end portion of the battery 21, and the negative pole terminals 21b of the plurality of batteries 21 and the negative pole metallic plate 23b are electrically connected to each other. In this manner, by disposing the positive pole metallic plate 23a and the negative pole metallic plate 23b, the plurality of batteries 21 is electrically connected in parallel to each other. Furthermore, as mentioned above, both end portions of the plurality of batteries 21 are fixed by the battery holder 22a and the battery holder 22b, whereby, when the vibration or the impact is applied to the battery unit 1, it is possible to protect a point of contact between the positive pole terminal portion 21a and the positive pole metallic plate 23a, and a point of contact between the negative pole terminal portion 21b and the negative pole metallic plate 23b. Moreover, it is possible to perform the insulation of a point of contact and an opposite pole part of the positive pole metallic plate 23a and the negative pole metallic plate 23b by the battery holder 22a and the battery holder 22b. Thus, it is possible to obtain high stability in a simpler manner in comparison to the structure of the related art. For example, the battery holder 22a electrically insulates the portion between the positive pole metallic plate 23a and the negative pole portion of the battery 21. For example, the negative pole portion of the battery 21 includes the negative pole terminal portion 21b, an outer periphery portion 21c and a negative pole surrounding portion 21d of the battery. The negative pole surrounding portion 21d is a portion around the positive pole terminal portion 21a. The negative pole surrounding portion 21d and the negative pole terminal portion 21b are electrically connected to each other. For example, when the circumference of the battery is covered with a heat shrinkable tube, the heat-shrinkable tube electrically insulates the surfaces of the outer periphery portion 21c and the negative pole surrounding portion 21d of the battery to the outside.

Battery

The battery 21 is, for example, a cylindrical battery which has the positive pole terminal portion 21a and the negative pole terminal portion 21b at both end portions. In addition, the shape of the battery is not limited to the cylindrical shape, and the batteries of various shapes such as a square shape can be used. The battery 21 is, for example, a secondary battery capable of being used repeatedly. As such a secondary battery, for example, a lithium ion secondary battery, a lithium ion polymer secondary battery or the like can be adopted.

Battery Holder

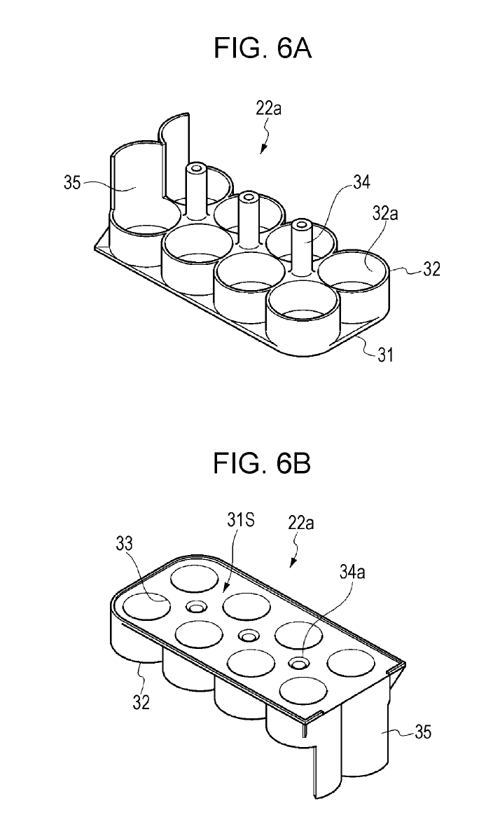

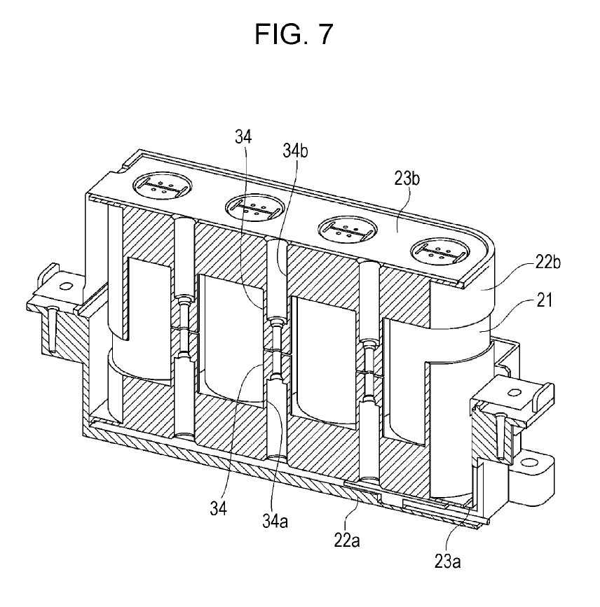

FIGS. 6A and 6B are perspective views that show an example of a configuration of the battery holder. FIG. 7 is a cross-sectional diagram that shows an example of a configuration of the battery block. Since the battery holder 22a and the battery holder 22b have the same shape, only a configuration of the battery holder 22a will be described hereinafter. In addition, the battery holder 22a and the battery holder 22b are not limited to the same shape, and it is also possible to adopt the configurations different from each other as necessary. As the materials of the battery holder 22a and the battery holder 22b, for example, an insulating material such as plastic is adopted. For example, the materials of the battery holder 22a and the battery holder 22b may be a heat conductive material that contains the metallic powder or carbon and has high heat conductivity. As a result, the heat generated by the battery 21 can effectively be radiated to the outside. For example, the materials of the battery holder 22a and the battery holder 22b may be reinforced plastic which contains glass fiber or carbon fiber and has an excellent mechanical strength. As a result, it is possible to enhance the whole strength of the battery unit 1 for when the battery unit 1 is dropped.

The battery holder 22a includes a base portion 31, a plurality of fixing portions 32, a plurality of opening portions 33, one or a plurality of fastening portions 34, and a wall portion 35. The base portion 31 has, for example, a plate-like shape, and a fixing portion 32 for fixing an end portion of the plurality of batteries 21 is formed on one main surface thereof. The fixing portion 32 has a configuration capable of fixing an end portion of the battery 21. For example, the fixing portion 32 has a hole portion 32a of a slightly shallow cylindrical shape or the like, and by fitting an end portion of the battery 21 of the cylindrical shape or the like to the hole portion 32a, an end portion of the battery 21 can be fixed. Another main surface of the base portion 31 is an electrode plate disposition surface 31S for disposing the positive pole metallic plate 23a or the negative pole metallic plate 23b.

On the bottom surface portion of the hole portion 32a of the fixing portion 32, an opening portion 33 is formed. The positive pole terminal portion 21a or the negative pole terminal portion 21b of the battery 21 and the positive pole metallic plate 23a or the negative pole metallic plate 23b are electrically connected to each other via the opening portion 33. On one main surface of the base portion 31, one or a plurality of fastening portions 34 is provided, and in a state in which both end portions of the battery 21 are fixed by the fixing portion 32 of the battery holder 22a and the battery holder 22b, as shown in FIG. 7, the front ends of the fastening portions 34 of both holders are oppositely disposed so as to come into contact with or come close to each other. In this state, by the screw or the like inserted into the hole portion 34a of the fastening portion 34, the battery holder 22a and the battery holder 22b are fastened to each other. In the end portion of one main surface of the base portion 31, a wall portion 35 erected on the one main surface is provided. By disposing a bending portion of the positive pole metallic plate 23a or the negative pole metallic plate 23b on the wall portion 35, it is possible to prevent the positive pole metallic plate 23a or the negative pole metallic plate 23b from coming into contact with the side surface of the battery 21. A temperature detection instrument may be provided in the battery holder 22a or the battery holder 22b. By doing so, it is possible to obtain high workability and stability.

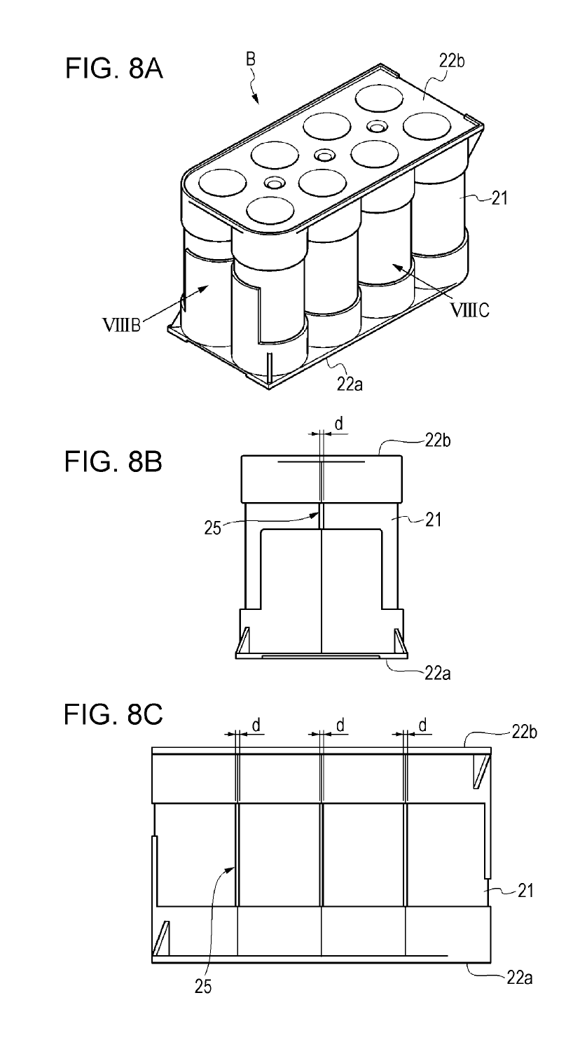

FIG. 8A is a perspective view of a battery block in a state in which a positive pole metallic plate and a negative pole metallic plate are removed. FIG. 8B is a side view which shows the battery block shown in FIG. 8A from a direction of an arrow VIIIB FIG. 8C is a side view which shows the battery block from a direction of an arrow VIIIC. It is preferable that the battery block 3 has a configuration capable of forming a space 25 among the plurality of batteries 21 to be fixed. As a result, the portion between the batteries can simply be insulated. Furthermore, the radiant heat property of the battery 21 can be improved.

Metallic Plate

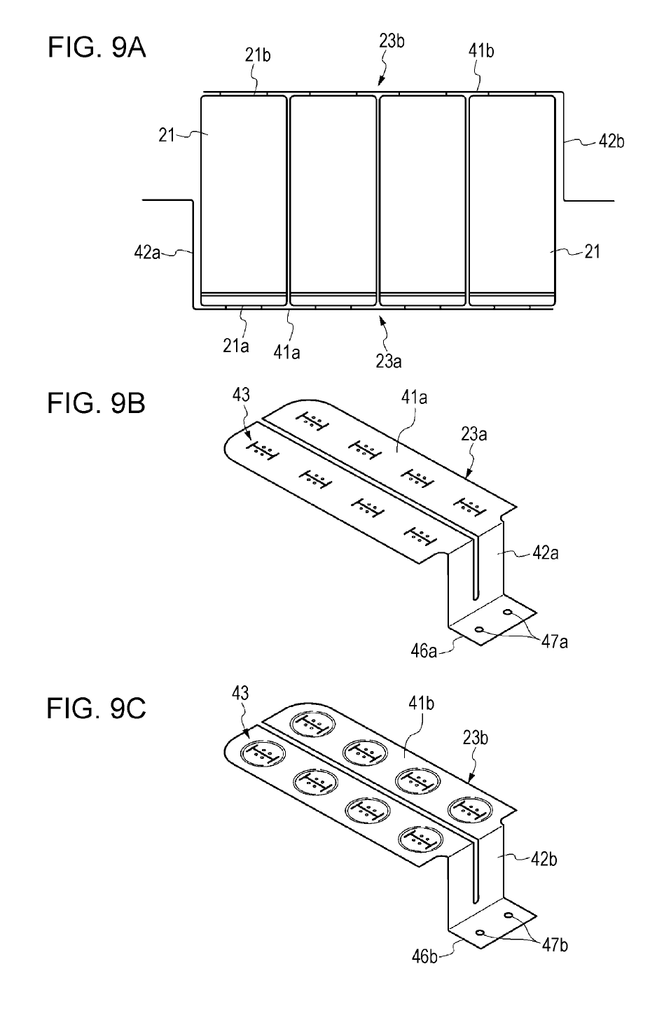

FIG. 9A is a side view of a battery block in a state in which a battery holder is removed. FIG. 9B is a perspective view that shows an example of a configuration of a positive pole metallic plate. FIG. 9C is a perspective view that shows an example of a configuration of a negative pole metallic plate. The positive pole metallic plate 23a has an L shape as a whole. The positive pole metallic plate 23a has a terminal connection portion 41a and a lead-out portion 42a that is bent to the terminal connection portion 41a. One main surface of the terminal connection portion 41a is electrically bonded to the positive pole terminal portions 21a of the plurality of batteries 21 fixed by the battery holder 22a. As the bonding method, for example, an electrical resistance welding or a welding by a laser light heating is adopted, but the method is not particularly limited to these methods, and existing welding methods of the related art can be suitably used. In the front end of the lead-out portion 42a, a connection portion 46a erected against the lead-out portion 42a is provided. In the connection portion 46a, one or a plurality of screw holes 47a is provided.

The negative pole metallic plate 23b has an L shape as a whole. The negative pole metallic plate 23b has a terminal connection portion 41b and a lead-out portion 42b that is bent to the terminal connection portion 41b. One main surface of the terminal connection portion 41b is electrically bonded to the negative pole terminal portions 21b of the plurality of batteries 21 fixed by the battery holder 22b. As the bonding method, for example, an electrical resistance welding or a welding by a laser light heating is adopted, but the method is not particularly limited to these methods, and existing welding methods of the related art can be suitably used. In the front end of the lead-out portion 42b, a connection portion 46b erected to the lead-out portion 42b is provided. In the connection portion 46b, one of a plurality of screw holes 47b is provided.

As the materials of the positive pole metallic plate 23a and the negative pole metallic plate 23b, it is preferable to use copper alloy, a material similar to that or the like. As a result, it is possible to supply electricity with low resistance. For example, the materials of the positive pole metallic plate 23a and the negative pole metallic plate 23b are nickel or nickel alloy. As a result, the weldability of the positive pole metallic plate 23a and the negative pole metallic plate 23b and the positive pole terminal portion 21a and the negative pole terminal portion 21b of the battery 21 becomes satisfactory. For example, the surfaces of the materials of the positive pole metallic plate 23a and the negative pole metallic plate 23b are plated with tin or nickel. As a result, it is possible to prevent an occurrence of rust due to the oxidation of the surfaces of the materials of the positive pole metallic plate 23a and the negative pole metallic plate 23b. It is desirable to dispose the positive pole metallic plate 23a and the negative pole metallic plate 23b so as to supply electricity in an opposite direction. The resistances of the respective batteries 21 can be adjusted, and a cycle property of the battery block B is improved. It is desirable to have a configuration in which the surfaces of the positive pole metallic plate 23a and the negative pole metallic plate 23b can be exposed. By constituting in this manner, the high radiant heat property can be obtained.

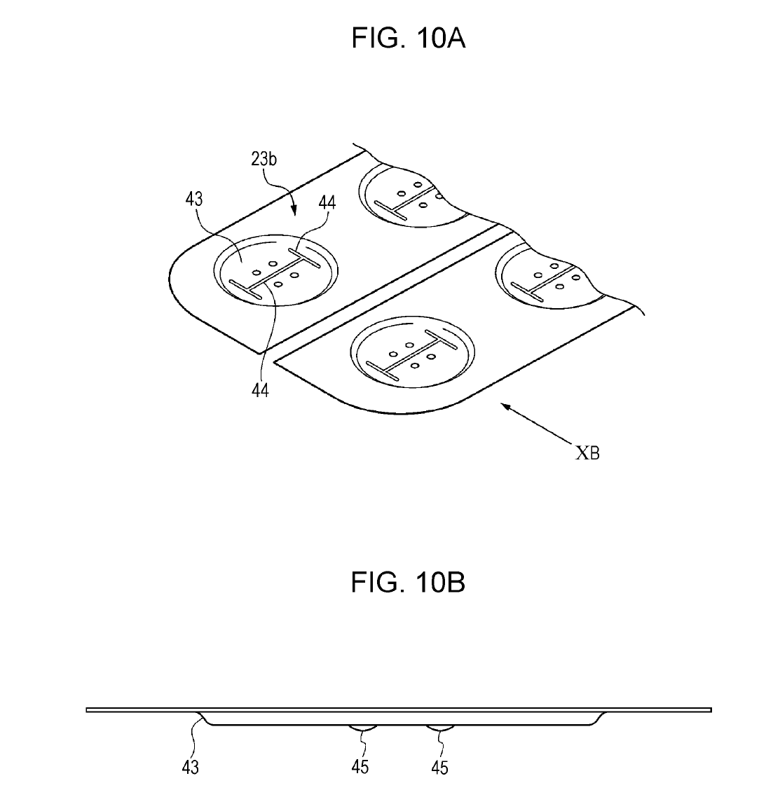

FIG. 10A is a perspective view that indicates a part of a terminal connection portion of a negative pole metallic plate in an enlarged manner. FIG. 10B is a side view which shows the negative pole metallic plate shown in FIG. 10A from a direction of an arrow XB. Hereinafter, a terminal connection portion of the negative pole metallic plate 23b will be described with reference to FIGS. 10A and 10B, but the positive pole metallic plate 23a can also have the same configuration.

The negative pole metallic plate 23b has a terminal contact portion 43 coming into contact with the negative pole terminal portion 21b of the battery 21. It is desirable that the terminal contact portion 43 has an aperture shape. As a result, it is possible to obtain an improvement in strength, erroneous insertion prevention and an excellent electrical contact property of the negative pole metallic plate 23b. It is desirable to provide a plurality of convex shape portions 45 on the contact surface of the terminal contact portion 43 of the negative pole metallic plate 23. As a result, it is possible to obtain an improvement in weldability and an excellent electrical contact property. It is desirable to provide one or a plurality of slits 44 in the terminal contact portion 43 of the negative pole metallic plate 23b. As a result, it is possible to obtain an improvement in weldability and a function of shutting off the electric current at the time of the occurrence of an external short circuit. Furthermore, by providing the slits 44, the wiring resistance near the terminal contact portion 43 is further enlarged, and when an abnormal discharging current flows in the battery block, it is possible to reduce the discharging current flowing from the battery 21 to the negative pole metallic plate 23b. For example, the slits 44 may be provided on the contact surface of the terminal contact portion 43 and the peripheral portion thereof.

Restriction Portion of Battery Block

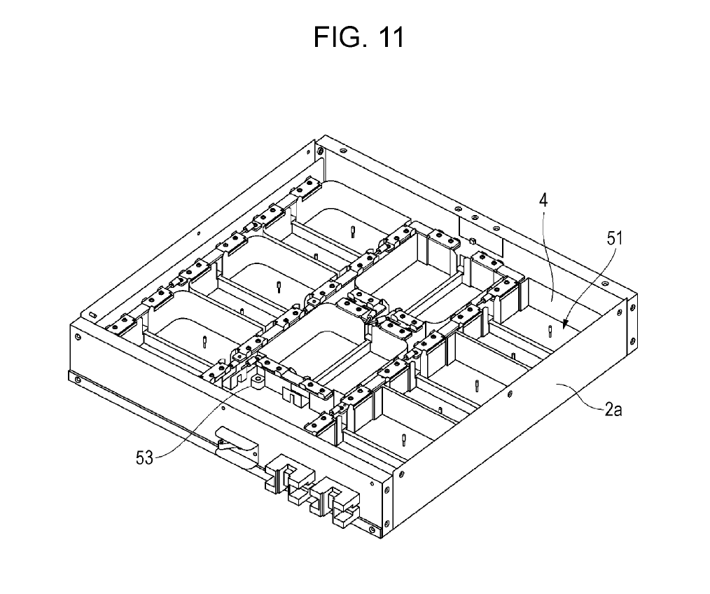

FIG. 11 is a perspective view that shows an example of a disposition of a battery block restriction portion. A plurality of battery block restriction portions 4 is disposed and fixed in the inside bottom surface of the exterior lower case 2a, for example, so as to form a plurality of rows. The battery block B is accommodated with respect to the battery block restriction portions 4 fixed in this manner.

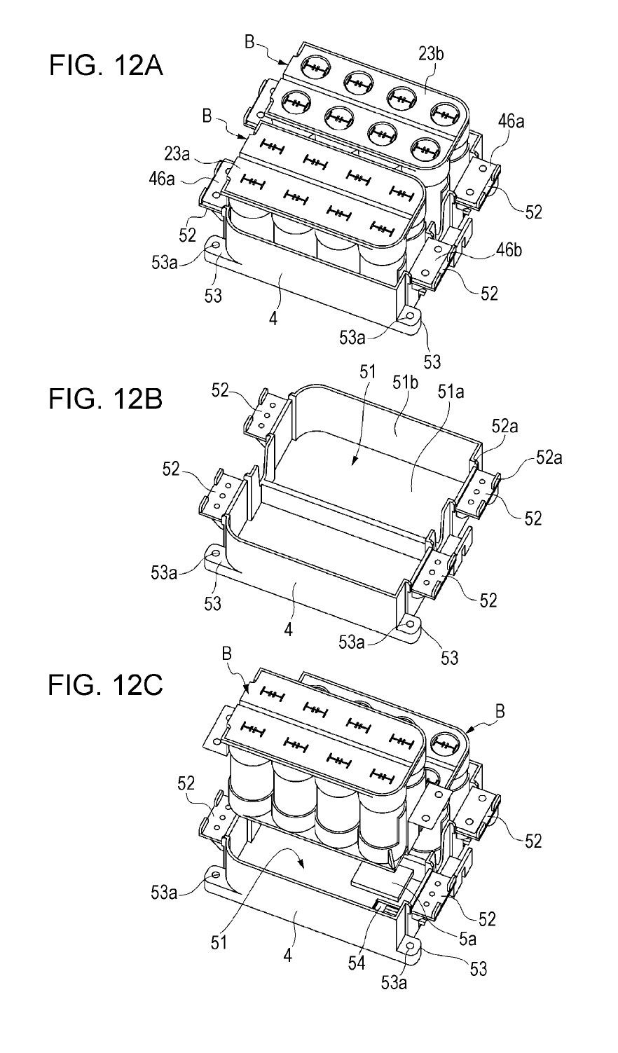

FIG. 12A is a perspective view that shows an overview of a battery block accommodated in a battery block restriction portion. FIG. 12B is a perspective view that shows an example of a configuration of a battery block restriction portion. FIG. 12C is a perspective view that shows a modified example of a battery block restriction portion. The battery block restriction portion 4 has one or a plurality of accommodation portions 51 that is configured in a manner that can restrict the position of the battery block B in the exterior case. The accommodation portion 51 includes a bottom surface portion 51a, and a wall portion 51b erected on the periphery of the bottom surface portion 51a. In addition, in FIGS. 12A to 12C, an example of the battery block restriction portion 4 capable of accommodating two battery blocks B is shown.

As the material of the battery block restriction portion 4, it is desirable to use an insulating material such as plastic. By using such a material, the battery block B and the case 2 can have configurations that can be insulated. That is, it is possible to interpose an insulative bottom surface portion 51a between the battery block B and the case 2. Thus, high stability can be obtained. For example, the material of the battery block restriction portion 4 may be a heat conductive material which contains metallic powder or carbon and has high heat conductivity. As a result, the heat generated by the battery 21 can effectively be radiated to the outside. For example, the material of the battery block restriction portion 4 may be reinforced plastic which contains metallic fiber or carbon fiber and the like and has an excellent mechanical strength. As a result, it is possible to enhance the whole strength of the battery unit 1 for the time when the battery unit 1 is dropped.

The battery block restriction portion 4 includes connector attachment portion 52 in both ends of one or the plurality of accommodation portions 51. The connection portion 46a or the connection portion 46b disposed on the connector attachment portion 52 is connected to the metal connection plate that is the connector. The connection portion 46a and the connection portion 46b of the adjoining battery blocks B are electrically connected to each other via the metal connection plate. In addition, the details of the metal connection plate will be described later.

The battery block restriction portion 4 has a configuration that can fix the connection portion 46a of the positive pole metallic plate 23a or the connection portion 46b of the negative pole metallic plate 23b. For example, the battery block restriction portion 4 includes a protrusion portion 52a for fixing the positive pole metallic plate 23a or the negative pole metallic plate 23b in the periphery of the connector attachment portion 52 or the vicinity thereof. As a result, the battery block restriction portion 4 is simple in comparison to the component of the related art and can obtain the high workability.

The battery block restriction portion 4 has a configuration (hereinafter, referred to as a reversal accommodation prevention structure) capable of restricting up and down and/or left and right accommodation directions of the battery block B. By having such a configuration, it is possible to realize erroneous insertion prevention and high workability at the time of the assembling operation of the battery unit 1. The battery block restriction portion 4 includes a plurality of fixing portions 53 in the periphery of the bottom surface portion thereof, and, for example, a screw hole 53a is provided in the fixing portion 53. By inserting, rotating and tightening the screw into the screw hole 53a and the screw hole of the fixing portion 16 provided in the exterior lower case 2a, the battery block restriction portion 4 can be fixed to the exterior lower case 2a. In addition, the fixing method of the battery block restriction portion 4 is not limited to screw tightening, for example, it is also possible to adopt a configuration in which a hook portion or the like provided in the battery block restriction portion 4 is fitted into the hole portion provided in the exterior lower case 2a. For example, it is also possible to adopt a configuration in which an adhesive or a gluing agent is disposed on the bottom surface of the battery block restriction portion 4 and is bonded and fixed with the exterior lower case 2a.

The battery block restriction portion 4 has a configuration that can protect the battery block B. Specifically, it is configured so that the accommodation portion of the battery block restriction portion 4 covers the bottom surface portion of the battery block B. As a result, when the vibration or the impact is applied to the battery unit 1, high stability is obtained.

The battery block restriction portion 4 has a configuration in which the electrode metallic plates (for example, the positive pole metallic plate 23a and the negative pole metallic plate 23b) of the battery blocks B disposed so as to be adjacent to each other can be insulated. Specifically, for example, the battery block restriction portion 4 has a wall portion 51b for preventing the contact between the electrode metallic plates, between the adjoining accommodation portions. By such a configuration, high stability can be obtained.

Temperature Detector

As shown in FIG. 12C, it is desirable to dispose a temperature detector 54 on the bottom surface portion 51a of the battery block restriction portion 4. As a result, since the temperature of the respective battery blocks can be detected, the stability can be improved. Furthermore, between the temperature detector 54 and the bottom surface of the battery block B, a material such as a shock absorbing material 5a may be provided which has a high electrical connectivity and high heat conductivity. In addition, the disposition position of the temperature detector 54 may be a position capable of detecting the temperature of the battery block, and may be directly disposed on the battery block B without being limited to the above-mentioned example. In addition, from the viewpoint of the assembly operation of the battery unit 1, it is desirable to dispose the temperature detector 54 on the bottom surface portion 51a of the battery block restriction portion 4. For example, an adhesive having high heat conductivity may be applied near a position where the shock absorbing material 5a is disposed.

Shock Absorbing Material

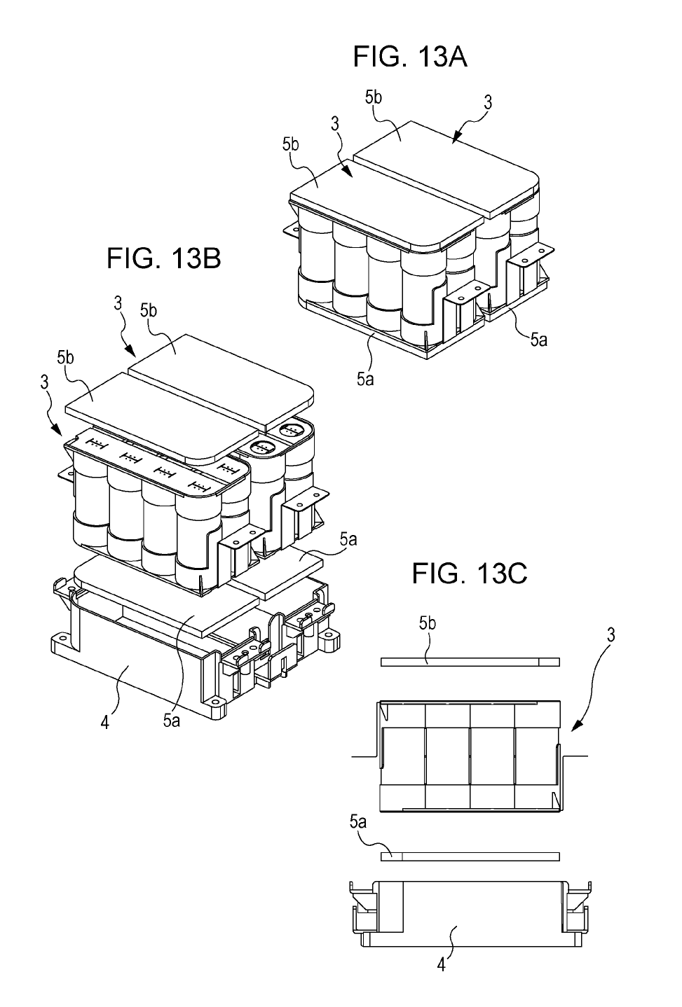

FIGS. 13A to 13C show an example of a configuration of a battery block with a shock absorbing material disposed thereon. It is desirable to dispose the shock absorbing materials 5a and 5b on the lower surface and the upper surface of the battery block B, respectively, thereby restricting the position of the battery block B via the shock absorbing materials 5a and 5b by the exterior lower case 2a and the exterior upper case 2b. By doing so, when the impact or the vibration is added to the battery unit 1, it is possible to prevent them from directly reaching the battery block B. For example, when the battery unit 1 is vibrated, since the shock absorbing materials 5a and 5b dampen the vibration, the acceleration and the amplitude of the vibration of the battery block B are smaller than those of the vibration of the battery unit 1. As shapes of the shock absorbing materials 5a and 5b, for example, a sheet shape, a plate shape or the like my be adopted, but the shapes are not particularly limited to these shapes. It is desirable that the shock absorbing materials 5a and 5b have a high shock absorbing property. It is preferable that the shock absorbing materials 5a and 5b have high heat conductivity. As a result, the high radiant heat property can be obtained. For example, the shock absorbing materials 5a and 5b are materials having high flexibility and high heat conductivity. For example, the shock absorbing materials 5a and 5b are materials containing silicone or acryl. For example, the shock absorbing materials 5a and 5b are materials containing metallic power or graphite. For example, the shock absorbing materials 5a and 5b have heat conductivity of about 0.5 W/m·K or more. As the shapes of the shock absorbing materials 5a and 5b, for example, a sheet shape or a plate shape may be adopted, but, the shapes are not particularly limited these shapes. It is desirable that the shock absorbing materials 5a and 5b have high heat conductivity. As a result, the high radiant heat property can be obtained.

Reversal Accommodation Preventing Structure

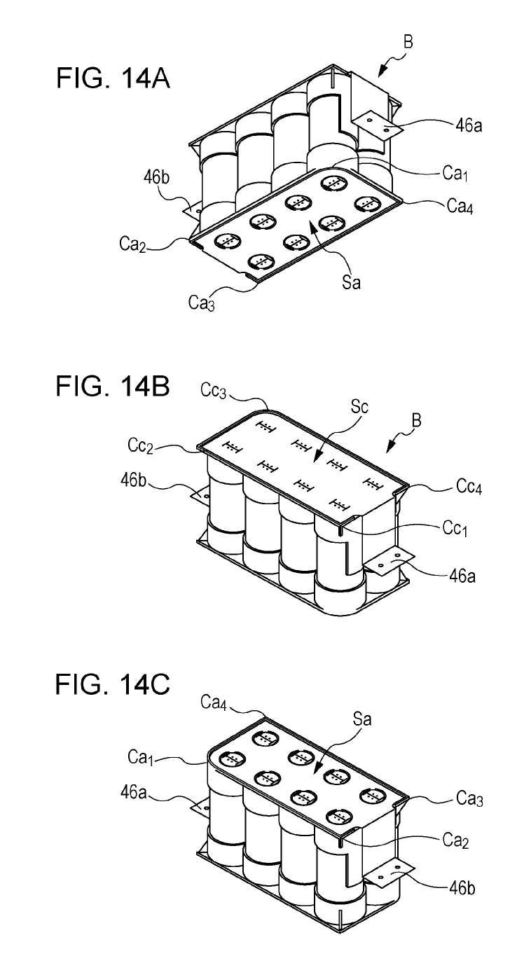

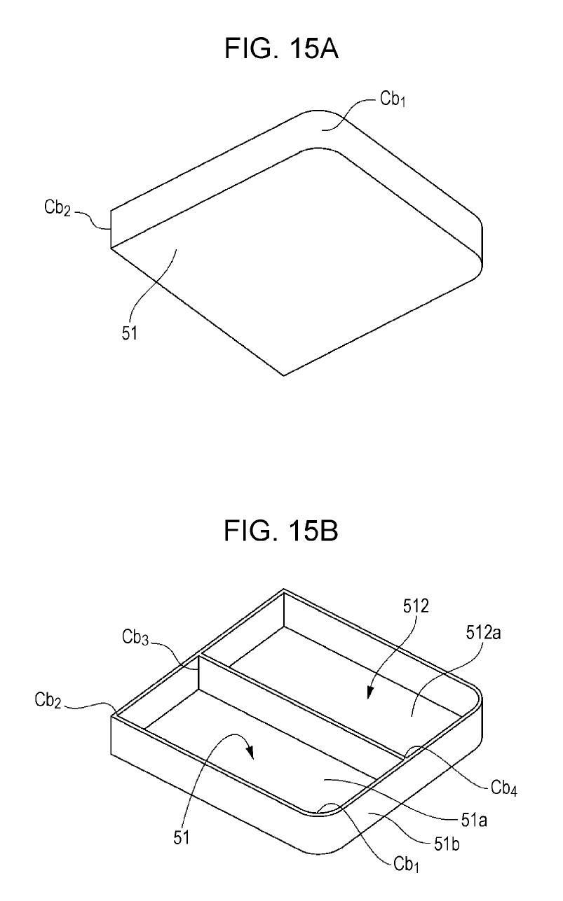

Hereinafter, a first example to a fourth example of a reversal accommodation preventing structure of a battery block B will be described with reference to FIGS. 14A to 25D. In addition, a surface with the positive pole metallic plate 23a of the battery block B disposed thereon is called a positive pole terminal surface Sc, and a surface with the negative pole metallic plate 23b of the battery block B disposed thereon is called a negative pole terminal surface Sa. Furthermore, in FIGS. 15A to 15B, 16A to 16D, 18A and 18B, 19A to 19D, 21A and 21B, 22A to 22D, 24A and 24B, and 25A to 25D, in order to facilitate the description of the reversal accommodation preventing structure, a simplified configuration of the accommodation portion 51 of the battery block restriction portion 4 is shown.

### First Example

### Shape of Electrode Terminal Surface

FIG. 14A is a perspective view at the time of viewing a negative pole terminal surface side of a battery block from a lower part. FIG. 14B is a perspective view at the time of viewing a positive pole terminal surface side of a battery block from an upper part. FIG. 14C is a perspective view at the time of viewing a negative pole terminal surface side of a battery block from an upper part. The battery block B has a negative pole terminal surface Sa and a positive pole terminal surface Sc that have approximately opposing rectangular shapes. The negative pole terminal surface Sa has four angular portions Ca₁ to Ca₄, only one angular portion Ca₁ among four angular portions Ca₁ to Ca₄ is an angular portion having a curvature of R, and the other three angular portions Ca₂ to Ca₄ are angular portions of a right angle. The positive pole terminal surface Sc has four angular portions Cc₁ to Cc₄, only one angular portion Cc₃ among four angular portions Cc₁ to Cc₄ is an angular portion having a curvature of R, and the other three angular portions Cc₁, Cc₂ and Cc₄ are angular portions of a right angle.

The shape of the negative pole terminal surface Sa and the shape of the positive pole terminal surface Sc are have a point symmetrical relationship. That is, when one terminal surface is rotated around a center thereof, that is, around a symmetrical point by 180°, both terminal surfaces have an overlapped relationship.

Shape of Accommodation Portion

FIG. 15A is a perspective view at the time of viewing an accommodation portion of a battery block restriction portion from a lower part. FIG. 15B is a perspective view at the time of viewing an accommodation portion of a battery block restriction portion from an upper part. A first accommodation portion 51 and a second accommodation portion 512 of the battery block restriction portion 4 have configurations which can accommodate one battery block B, respectively. That is, the battery block restriction portion 4 has two adjoining accommodation portions (the first accommodation portion 51 and the second accommodation portion 512). A bottom surface portion 51a of one accommodation portion 51 has approximately a rectangular shape which is slightly greater than the negative pole terminal surface Sa, and is configured so that it can accommodate the negative pole terminal surface side of the battery block B directed in a predetermined direction. A bottom surface portion 512a of the other accommodation portion 512 has approximately a rectangular shape which is slightly greater than the positive pole terminal surface Sc, and is configured so that it can accommodate the positive pole terminal surface side of the battery block B directed in a predetermined direction.

The wall portion 51b erected in the periphery of the accommodation portion 51 has four angular portions Cb₁ to Cb₄, only one angular portion Cb₁ among four angular portions Cb₁ to Cb₄ is an angular portion having a curvature of R, and the other three angular portions Cb₂ to Cb₄ are angular portions of a right angle.

Reversal Accommodation Preventing Structure

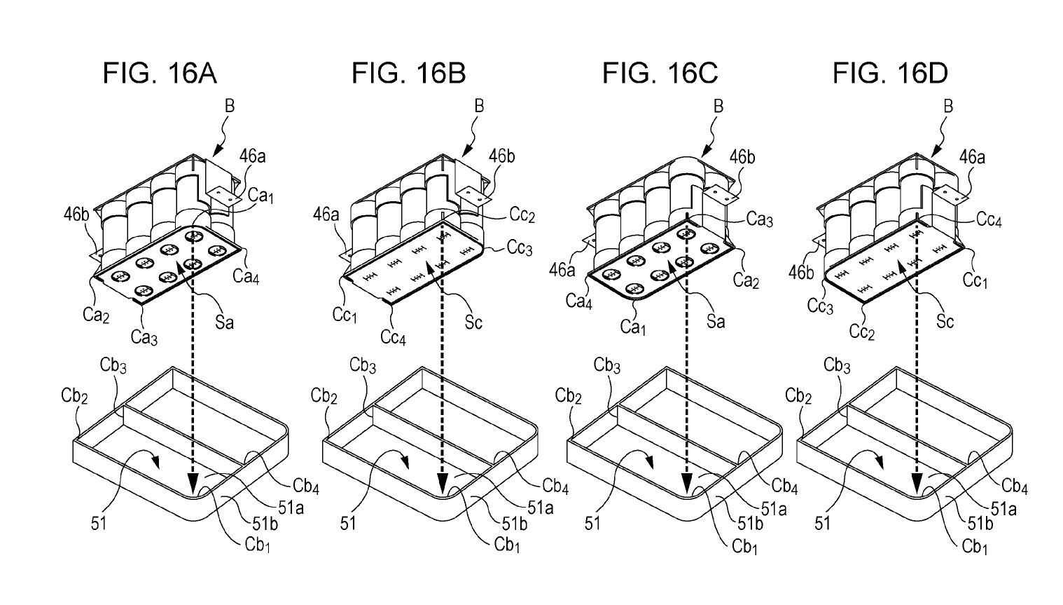

FIG. 16A is a perspective view that shows a correct accommodation direction of a battery block B relative to an accommodation portion. FIGS. 16B to 16D are perspective views that show incorrect accommodation directions of a battery block B relative to an accommodation portion. Herein, a direction of a connection portion 46a and a connection portion 46b of the battery block B are called a left to right direction, and a direction of the positive pole terminal surface Sc and the negative pole terminal surface Sa of the battery block B is called a vertical direction. The negative pole terminal surface Sa of the positive pole terminal surface Sc and the negative pole terminal surface Sa have approximately the same shape as the bottom surface portion 51a of the accommodation portion 51 in the state of being disposed opposite to the accommodation portion 51. The positive pole terminal surface Sc of the positive pole terminal surface Sc and the negative pole terminal surface Sa have approximately the same shape as the bottom surface portion 512a of the accommodation portion 512 in the state of being disposed opposite to the accommodation portion 512.

FIG. 16A shows an example in which the battery block B is accommodated in a correct accommodation direction. When the accommodation direction of the battery block B relative to the accommodation portion 51 is adjusted so that the negative pole terminal surface Sa becomes the lower side and the connection portion 46a for the positive pole becomes the front side, since the angular portion Ca₁ of an R shape of the negative pole terminal surface Sa does not interfere with the angular portion Cb₁ of an R shape of the accommodation portion 51, the battery block B can be accommodated in the accommodation portion 51.

FIG. 16B shows an example in which the accommodation direction of the battery block B is reversed left and right and is reversed up and down with respect to the correct accommodation direction shown in FIG. 16A. When the accommodation direction of the battery block B relative to the accommodation portion 51 is adjusted so that the positive pole terminal surface Sc becomes the lower side and the connection portion 46b for the negative pole becomes the front side, since the angular portion Cc₂ of right angle of the positive pole terminal surface Sc interferes in the angular portion Cb₁ of an R shape of the accommodation portion 51, it is difficult to accommodate the battery block B in the accommodation portion 51.

FIG. 16C shows an example in which the accommodation direction of the battery block B is reversed left and right with respect to the correct accommodation direction shown in FIG. 16A. When the accommodation direction of the battery block B relative to the accommodation portion 51 is adjusted so that the negative pole terminal surface Sa becomes the lower side and the connection portion 46b for the negative pole becomes the front side, since the angular portion Ca₃ of a right angle of the negative pole terminal surface Sa interferes in the angular portion Cb₁ of an R shape of the accommodation portion 51, it is difficult to accommodate the battery block B in the accommodation portion 51.

FIG. 16D shows an example in which the accommodation direction of the battery block B is reversed up and down with respect to the correct accommodation direction shown in FIG. 16A. When the accommodation direction of the battery block B relative to the accommodation portion 51 is adjusted so that the positive pole terminal surface Sc becomes the lower side and the connection portion 46a for the positive pole becomes the front side, since the angular portion Cc₄ of a right angle of the positive pole terminal surface Sc interferes in the angular portion Cb₁ of an R shape of the accommodation portion 51, it is difficult to accommodate the battery block B in the accommodation portion 51.

As mentioned above, by combining the shapes of the positive pole terminal surface Sc and the negative pole terminal surface Sa of the battery block B with the shape of the accommodation portion 51 of the battery block restriction portion 4, the accommodation direction of the battery block B relative to the accommodation portion 51 can be limited to one direction. That is, the accommodation directions of the battery block B relative to the accommodation portion 51 are four accommodation directions up, down, left, and right, but the accommodation direction can be limited to one direction among them. For this reason, it is possible to prevent a worker from erroneously reversing the directions of up-and-down and left-and-right of the battery block B and erroneously accommodating the battery block B in the assembling process of the battery unit 1. That is, it is possible to prevent the connection portion 46a for the positive pole and the connection portion 46b for the negative pole of the battery block B from being reversely connected to the metallic connection plate.

### Second Example

### Shape of Electrode Terminal Surface

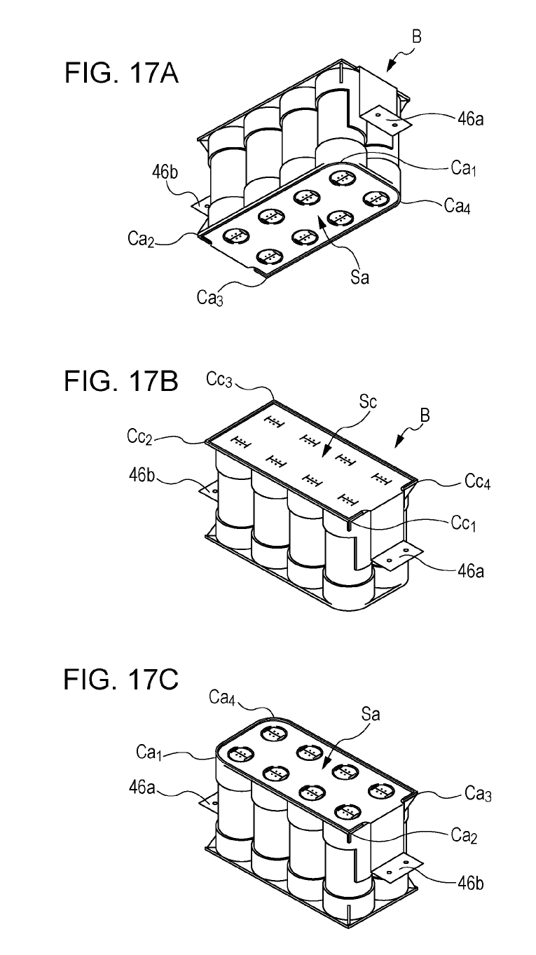

FIG. 17A is a perspective view at the time of viewing a negative pole terminal surface side of a battery block from a lower part. FIG. 17B is a perspective view at the time of viewing a positive pole terminal surface side of a battery block from an upper part. FIG. 17C is a perspective view at the time of viewing a negative pole terminal surface side of a battery block from an upper part. The battery block B has a negative pole terminal surface Sa and a positive pole terminal surface Sc that have approximately opposing rectangular shapes. The negative pole terminal surface Sa has four angular portions Ca₁ to Ca₄, only the adjoining two angular portions Ca₁ and Ca₄ among four angular portions Ca₁ to Ca₄ are angular portions having a curvature of R, and the other two angular portions Ca₂ and Ca₃ are angular portions of a right angle. The positive pole terminal surface Sc has four angular portions Cc₁ to Cc₄, none of the four angular portions Cc₁ to Cc₄ is an angular portion having a curvature of R, and all the angular portions Cc₁ to Cc₄ are angular portions of a right angle.

Shape of Accommodation Portion

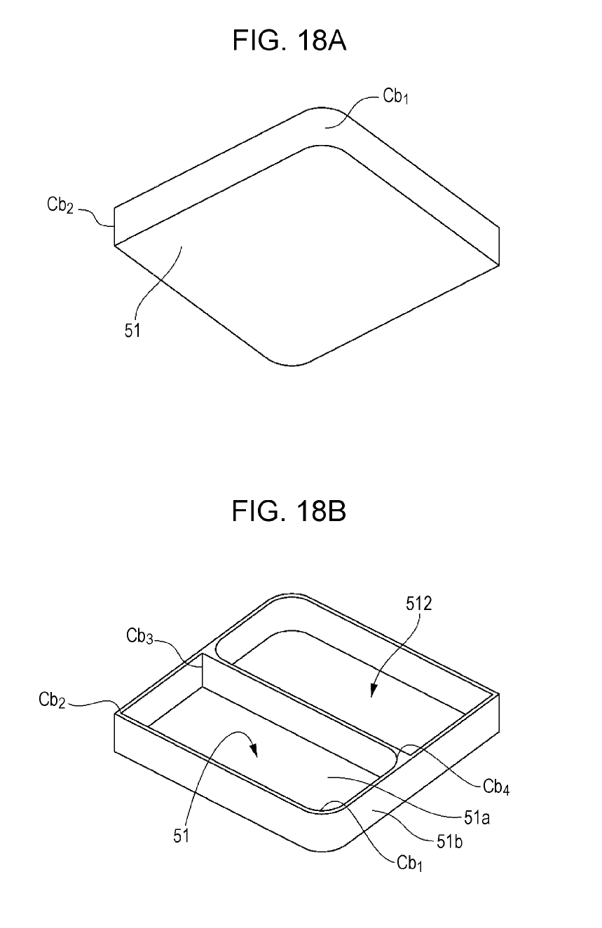

FIG. 18A is a perspective view at the time of viewing an accommodation portion of a battery block restriction portion from a lower part. FIG. 18B is a perspective view at the time of viewing an accommodation portion of a battery block restriction portion from an upper part. The wall portion 51b erected in the periphery of the accommodation portion 51 has four angular portions Cb₁ to Cb₄, only two angular portions Cb₁ and Cb₄ among four angular portions Cb₁ to Cb₄ are angular portions having a curvature of R, and the other two angular portions Cb₂ and Cb₃ are angular portions of a right angle.

Reversal Accommodation Preventing Structure

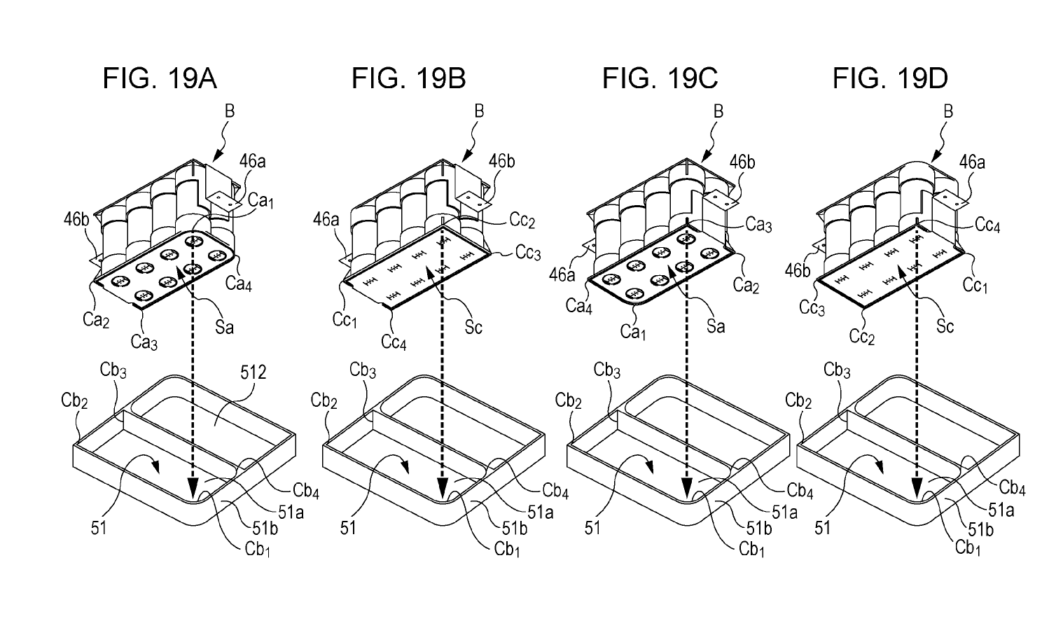

FIG. 19A is a perspective view that shows a correct accommodation direction of a battery block B relative to an accommodation portion. FIGS. 19B to 19D are perspective views that show incorrect accommodation directions of a battery block B relative to an accommodation portion. Among the positive pole terminal surface Sc and the negative pole terminal surface Sa, the negative pole terminal surface Sa, in which the curvature R is added to the adjoining two angular portions Ca₁ and Ca₄, has approximately the same shape as the bottom surface portion 51a of the accommodation portion 51 or the bottom surface portion 512a of the accommodation portion 512 in the state of being disposed opposite to the accommodation portion 51 or the accommodation portion 512.

FIG. 19A shows an example in which the battery block B is accommodated in a correct accommodation direction. When the accommodation direction of the battery block B relative to the accommodation portion 51 is adjusted so that the negative pole terminal surface Sa becomes the lower side and the connection portion 46a for the positive pole becomes the front side, since the angular portions Ca₁ and Ca₄ of an R shape of the negative pole terminal surface Sa do not interfere with the angular portions Cb₁ and Cb₄ of an R shape of the accommodation portion 51, the battery block B can be accommodated in the accommodation portion 51.

FIG. 19B shows an example in which the accommodation direction of the battery block B is reversed left and right and is reversed up and down with respect to the correct accommodation direction shown in FIG. 19A. When the accommodation direction of the battery block B relative to the accommodation portion 51 is adjusted so that the positive pole terminal surface Sc becomes the lower side and the connection portion 46b for the negative pole becomes the front side, since the angular portions Cc₂ and Cc₃ of a right angle of the positive pole terminal surface Sc interferes in the angular portions Cb₁ and Cb₄ of an R shape of the accommodation portion 51, it is difficult to accommodate the battery block B in the accommodation portion 51.

FIG. 19C shows an example in which the accommodation direction of the battery block B is reversed left and right with respect to the correct accommodation direction shown in FIG. 19A. When the accommodation direction of the battery block B relative to the accommodation portion 51 is adjusted so that the negative pole terminal surface Sa becomes the lower side and the connection portion 46b for the negative pole becomes the front side, since the angular portions Ca₃ and Caₜ of a right angle of the negative pole terminal surface Sa interfere with the angular portions Cb₁ and Cb₄ of an R shape of the accommodation portion 51, it is difficult to accommodate the battery block B in the accommodation portion 51.

FIG. 19D shows an example in which the accommodation direction of the battery block B is reversed up and down with respect to the correct accommodation direction shown in FIG. 19A. When the accommodation direction of the battery block B relative to the accommodation portion 51 is adjusted so that the positive pole terminal surface Sc becomes the lower side and the connection portion 46a for the positive pole becomes the front side, since the angular portions Cc₄ and Cc₁ of right angle of the positive pole terminal surface Sc interfere with the angular portions Cb₁ and Cb₄ of an R shape of the accommodation portion 51, it is difficult to accommodate the battery block B in the accommodation portion 51.

As mentioned above, by combining the shapes of the positive pole terminal surface Sc and the negative pole terminal surface Sa of the battery block B with the shape of the accommodation portion 51 of the battery block restriction portion 4, the accommodation direction of the battery block B relative to the accommodation portion 51 can be limited to one direction. The combination of the shapes of the positive pole terminal surface Sc and the negative pole terminal surface Sa with the shape of the accommodation portion 51 is most desirable. By adopting such a combination, since the R shape is given to two angular portions Ca₁ and Caₒ of the negative pole terminal surface Sa of the battery block B, a worker may easily distinguish the correct accommodation direction of the battery block B. Furthermore, since the accommodation direction of the battery block B can be limited to one direction, there is an advantage in that the possibility of erroneously accommodating the battery block B does not exist. Furthermore, in the above-mentioned combination, since the R shape is given to the angular portion of the negative pole terminal surface Sa of the battery block B, the positive pole terminal surface Sc of the battery block B can necessarily be set to the upside.

By combining the shapes of the positive pole terminal surface Sc and the negative pole terminal surface Sa of the battery block B with the shape of the accommodation portion 51 of the battery block restriction portion 4, it is possible to necessarily dispose the connection portion 46a for the positive pole in the front side of the accommodation portion 51 and set the upper surface of the battery block B as the positive pole terminal surface Sc. On the other hand, by combining the shapes of the positive pole terminal surface Sc and the negative pole terminal surface Sa of the battery block B with the shape of the accommodation portion 512 of the battery block restriction portion 4, it is possible to necessarily dispose the connection portion 46b for the negative pole in the front of the accommodation portion 512 and set the upper surface of the battery block B as the positive pole terminal surface Sc. In the above case, the connection portion 46a for the positive pole of the front side of the first battery block B disposed in the accommodation portion 51 and the connection portion 46b for the negative pole of the front of the second battery block B disposed in the accommodation portion 512 are connected by a metallic connection plate. For this reason, it is possible to prevent a worker from erroneously reversing the directions of up-and-down and left-and-right of the battery block B and erroneously accommodating the battery block B in the assembling process of the battery unit. That is, it is possible to prevent the connection portion 46a for the positive pole and the connection portion 46b for the negative pole of the battery block B from erroneously being reversely connected to the metallic connection plate.

### Third Example

### Shape of Electrode Terminal Surface

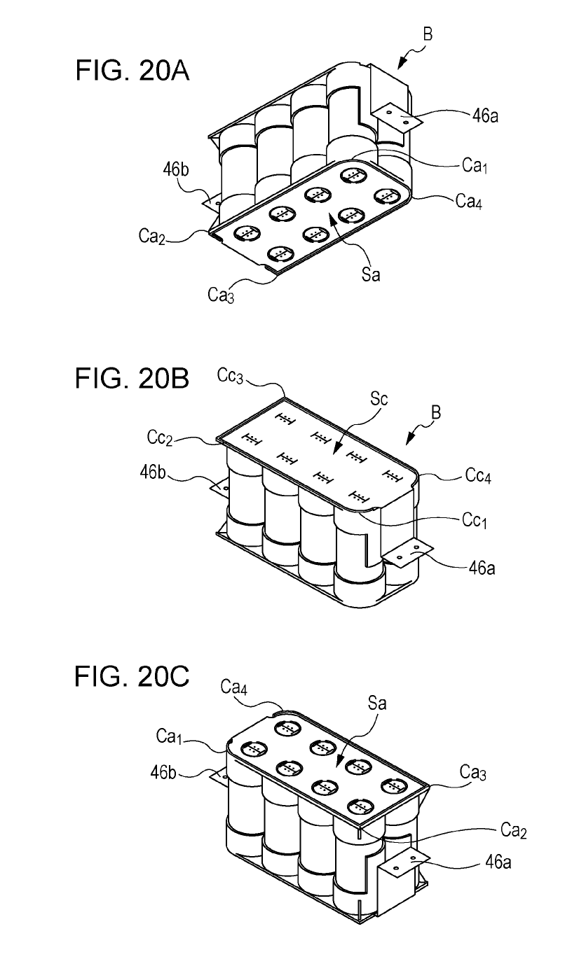

FIG. 20A is a perspective view at the time of viewing a negative pole terminal surface side of a battery block from a lower part. FIG. 20B is a perspective view at the time of viewing a positive pole terminal surface side of a battery block from an upper part. FIG. 20C is a perspective view at the time of viewing a positive pole terminal surface side of a battery block from an upper part. The battery block B has a negative pole terminal surface Sa and a positive pole terminal surface Sc that have approximately opposing rectangular shapes. The negative pole terminal surface Sa has four angular portions Ca₁ to Ca₄, only two adjoining angular portions Ca₁ and Ca₄ among four angular portions Ca₁ to Caₒ are angular portions having a curvature of R, and the other two angular portions Ca₂ and Ca₃ are angular portions of a right angle. The positive pole terminal surface Sc has four angular portions Cc₁ to Cc₄, only two adjoining angular portions Cc₁ and Cc₄ among four angular portions Cc₁ to Cc₄ are angular portions having a curvature of R, and the other two angular portions Cc₂ and Cc₃ are angular portions of a right angle. The shape of the positive pole terminal surface Sc and the shape of the negative pole terminal surface Sa have a point symmetry relationship. That is, when one terminal surface is rotated around a center of gravity thereof, that is, around a symmetrical point by 180°, both terminal surfaces have an overlapped relationship.

Shape of Accommodation Portion

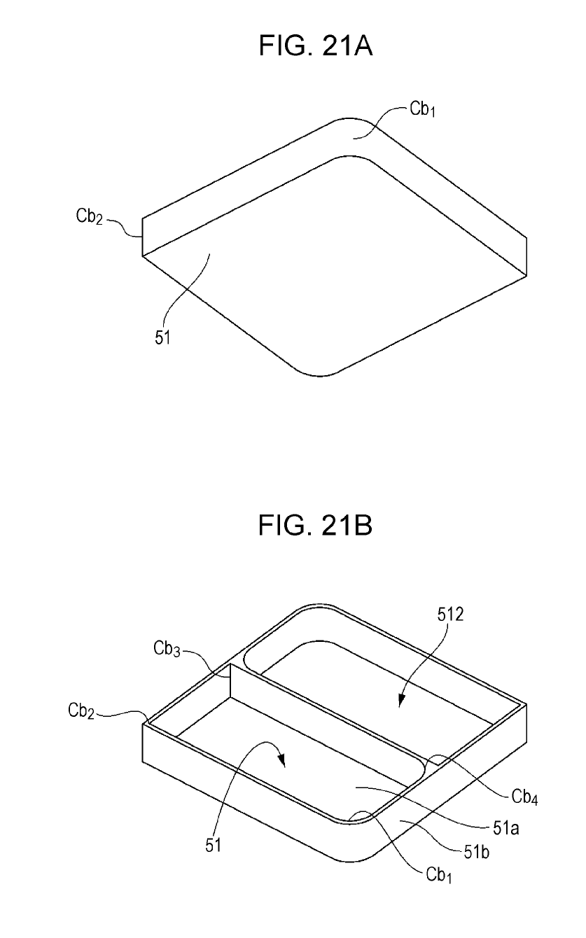

FIG. 21A is a perspective view at the time of viewing an accommodation portion of a battery block restriction portion from a lower part. FIG. 21B is a perspective view at the time of viewing an accommodation portion of a battery block restriction portion from an upper part. The wall portion 51b erected in the periphery of the accommodation portion 51 has four angular portions Cb₁ to Cb₄, only two angular portions Cb₁ and Cb₄ among four angular portions Cb₁ to Cb₄ are angular portions having a curvature of R, and the other two angular portions Cb₂ and Cb₃ are angular portions of a right angle.

Reversal Accommodation Preventing Structure

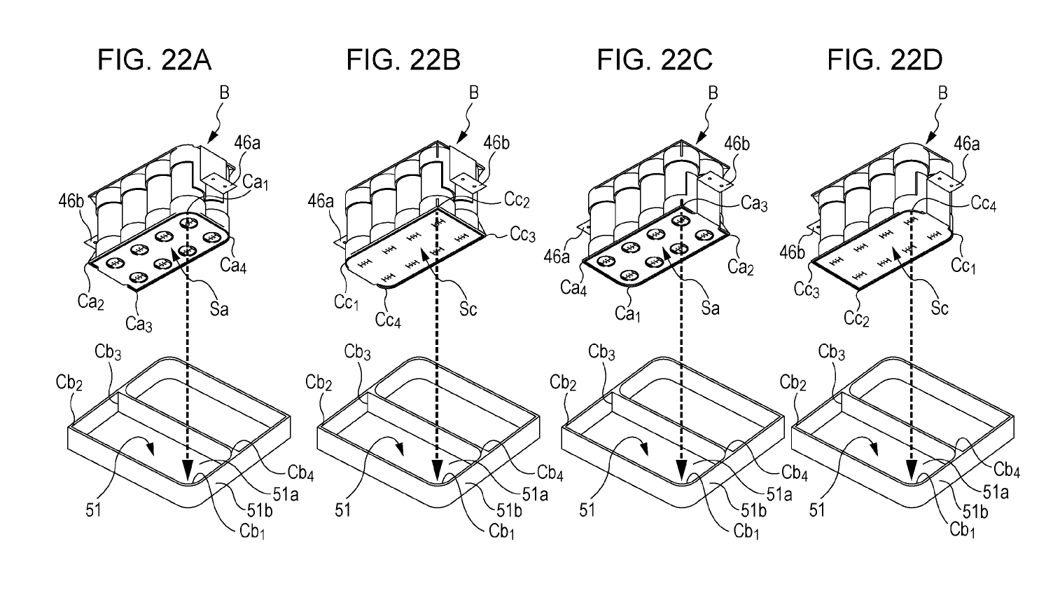

FIGS. 22A and 22D show an example in which a battery block B is accommodated in a correct accommodation direction. FIGS. 22B and 22C are perspective views that show incorrect accommodation directions of a battery block B relative to an accommodation portion. The positive pole terminal surface Sc and the negative pole terminal surface Sa has approximately the same shape as the bottom surface portion 51a of the accommodation portion 51 or the bottom surface portion 512a of the accommodation portion 512, in the state of being disposed opposite to the accommodation portion 51 or the accommodation portion 512.

FIG. 22A shows a correct accommodation direction of a battery block B relative to an accommodation portion. When the accommodation direction of the battery block B relative to the accommodation portion 51 is adjusted so that the negative pole terminal surface Sa becomes the lower side and the connection portion 46a for the positive pole becomes the front side, since the angular portions Ca1 and Ca4 of an R shape of the negative pole terminal surface Sa do not interfere with the angular portions Cb1 and Cb4 of an R shape of the accommodation portion 51, the battery block B can be accommodated in the accommodation portion 51.

FIG. 22B shows an example in which the accommodation direction of the battery block B is reversed left and right and is reversed up and down with respect to the correct accommodation direction shown in FIG. 22A. When the accommodation direction of the battery block B relative to the accommodation portion 51 is adjusted so that the positive pole terminal surface Sc becomes the lower side and the connection portion 46b for the negative pole becomes the front side, since the angular portions Cc2 and Cc3 of a right angle of the positive pole terminal surface Sc interfere with the angular portions Cb1 and Cb4 of an R shape of the accommodation portion 51, it is difficult to accommodate the battery block B in the accommodation portion 51.

FIG. 22C shows an example in which the accommodation direction of the battery block B is reversed left and right with respect to the correct accommodation direction shown in FIG. 22A. When the accommodation direction of the battery block B relative to the accommodation portion 51 is adjusted so that the negative pole terminal surface Sa becomes the lower side and the connection portion 46b for the negative pole becomes the front side, since the angular portions Ca3 and Ca2 of right angle of the negative pole terminal surface Sa interfere with the angular portions Cb1 and Cb4 of an R shape of the accommodation portion 51, it is difficult to accommodate the battery block B in the accommodation portion 51.

FIG. 22D shows a correct accommodation direction of a battery block B relative to an accommodation portion. When the accommodation direction of the battery block B relative to the accommodation portion 51 is adjusted so that the positive pole terminal surface Sc becomes the lower side and the connection portion 46a for the positive pole becomes the front side, since the angular portions Cc4 and Cc1 of the R shape of the positive pole terminal surface Sc do not interfere with the angular portions Cbl and Cb4 of the R shape of the accommodation portion 51, the battery block B can be accommodated in the accommodation portion 51.

In both accommodation directions shown in FIGS. 22A and 22D, the connection portion 46a for the positive pole is disposed in the front side. For this reason, even in any accommodation direction shown in FIGS. 22A and 22D, the electrical connection relationship of the connection portion 46a for the positive pole and the connection portion 46b for the negative pole relative to the connection metallic plate become identical to each other. That is, the function of the electrical connection is identical.

As mentioned above, by combining the shapes of the positive pole terminal surface Sc and the negative pole terminal surface Sa of the battery block B with the shape of the accommodation portion 51 of the battery block restriction portion 4, the left and right accommodation directions of the battery block B relative to the accommodation portion 51 can be limited to one direction. That is, even when the accommodation direction of the battery block B relative to the accommodation portion 51 is reversed up and down, the battery block B can be accommodated, but the left and right accommodation direction of the battery block B relative to the accommodation portion 51 can be limited to one direction.

By combining the shapes of the positive pole terminal surface Sc and the negative pole terminal surface Sa of the battery block B with the shape of the accommodation portion 51 of the battery block restriction portion 4, it is possible to necessarily dispose the connection portion 46a for the positive pole in the front side of the accommodation portion 51. For this reason, it is possible to prevent a worker from erroneously reversing the directions of left-and-right of the battery block B and erroneously accommodating the battery block B in the assembling process of the battery unit 1. That is, it is possible to prevent the connection portion 46a for the positive pole and the connection portion 46b for the negative pole of the battery block B from being reversely connected to the metallic connection plate.

### Fourth Example

### Shapes of Electrode Terminal Surface and Accommodation Portion

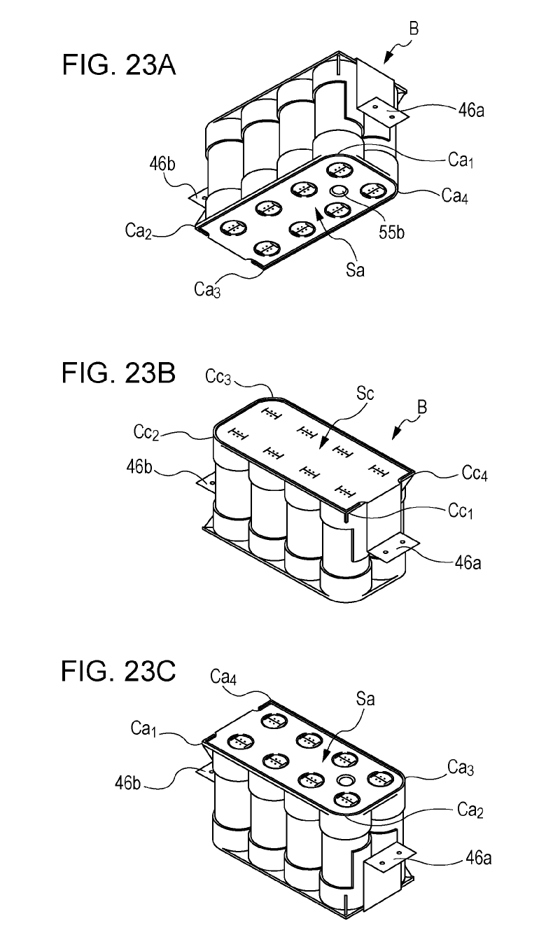

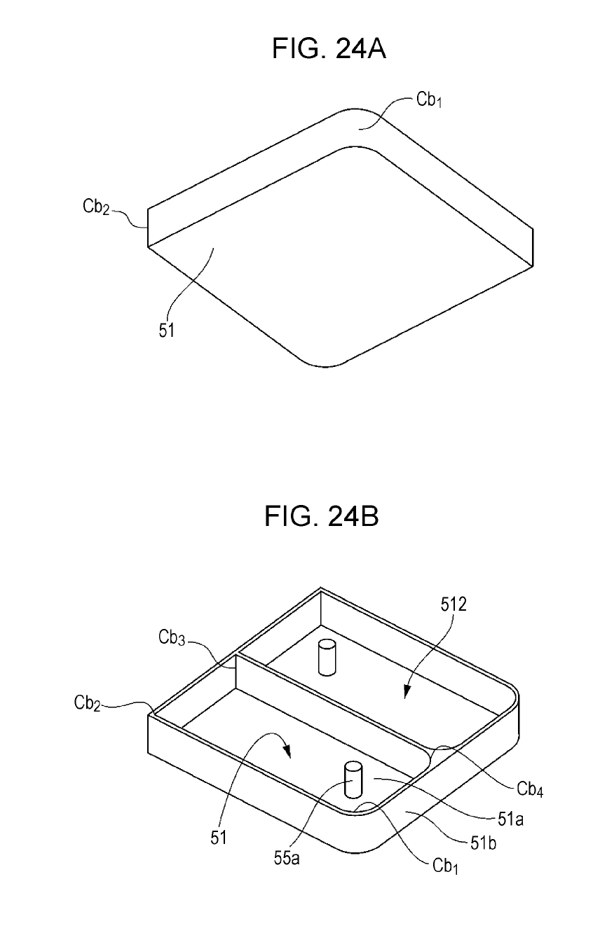

FIG. 23A is a perspective view at the time of viewing a negative pole terminal surface side of a battery block from a lower part. FIG. 23B is a perspective view at the time of viewing a positive pole terminal surface side of a battery block from an upper part. FIG. 23C is a perspective view at the time of viewing a negative pole terminal surface side of a battery block from an upper part. FIG. 24A is perspective view at the time of viewing an accommodation portion of a battery block restriction portion from a lower part. FIG. 24B is a perspective view at the time of viewing an accommodation portion of a battery block restriction portion from an upper part. The negative pole terminal surface Sa includes at least one concave portion 55b such as a hole at a position deviated from the center thereof, but the positive pole terminal surface Sc does not include the concave portion 55b. The accommodation portion 51 has a convex portion (also called a boss) 55a of a rod shape or the like at a position deviated from the center of the bottom surface thereof. When the battery block B is directed in a correct accommodation direction up-and-down and left-and right with respect to the accommodation portion 51, the concave portion 55b of the negative pole terminal surface Sa and the convex portion 55a of the accommodation portion 51 are disposed opposite to each other.

Reversal Accommodation Preventing Structure

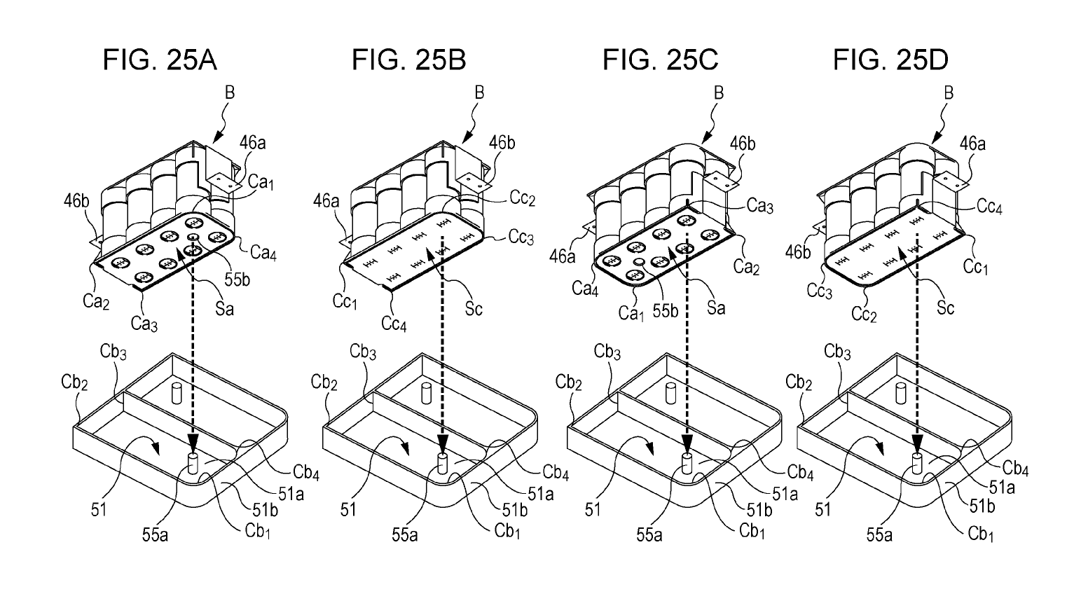

FIG. 25A shows an example in which a battery block B is accommodated in a correct accommodation direction. When the accommodation direction of the battery block B relative to the accommodation portion 51 is adjusted so that the negative pole terminal surface Sa becomes the lower side and the connection portion 46a for the positive pole becomes the front side, the convex portion 55a can be inserted into the concave portion 55b. That is, the negative pole terminal surface Sa does not interfere with the convex portion 55a of the accommodation portion 51. Thus, the battery block B can be accommodated in the accommodation portion 51.

FIG. 25B shows an example in which an accommodation direction of a battery block B is reversed left and right and is reversed up and down with respect to the correct accommodation direction shown in FIG. 25A. When the accommodation direction of the battery block B relative to the accommodation portion 51 is adjusted so that the positive pole terminal surface Sc becomes the lower side and the connection portion 46b for the negative pole becomes the front side, since the positive pole terminal surface Sc does not interfere with the convex portion 55a of the accommodation portion 51, it is difficult to accommodate the battery block B in the accommodation portion 51.

FIG. 25C shows an example in which an accommodation direction of a battery block B is reversed left and right with respect to the correct accommodation direction shown in FIG. 25A. When the accommodation direction of the battery block B relative to the accommodation portion 51 is adjusted so that the negative pole terminal surface Sa becomes the lower side and the connection portion 46b for the negative pole becomes the front side, since the negative pole terminal surface Sa interferes in the convex portion 55a of the accommodation portion 51, it is difficult to accommodate the battery block B in the accommodation portion 51.

FIG. 25D shows an example in which an accommodation direction of a battery block B is reversed up and down with respect to the correct accommodation direction shown in FIG. 25A. When the accommodation direction of the battery block B relative to the accommodation portion 51 is adjusted so that the positive pole terminal surface Sc becomes the lower side and the connection portion 46a for the positive pole becomes the front side, since the positive pole terminal surface Sc interferes in the convex portion 55a of the accommodation portion 51, it is difficult to accommodate the battery block B in the accommodation portion 51.

As mentioned above, by combining the shapes of the positive pole terminal surface Sc and the negative pole terminal surface Sa of the battery block B with the shape of the accommodation portion 51 of the battery block restriction portion 4, the accommodation directions of the battery block B relative to the accommodation portion 51 are four accommodation directions up, down, left, and right, but the accommodation direction can be limited to one direction among them. For this reason, it is possible to prevent a worker from erroneously reversing the directions of up-and-down and left-and-right of the battery block B and erroneously accommodating the battery block B in the assembling process of the battery unit 1. That is, it is possible to prevent the connection portion 46a for the positive pole and the connection portion 46b for the negative pole of the battery block B from being reversely connected to the metallic connection plate.

Connection Configuration of Battery Block

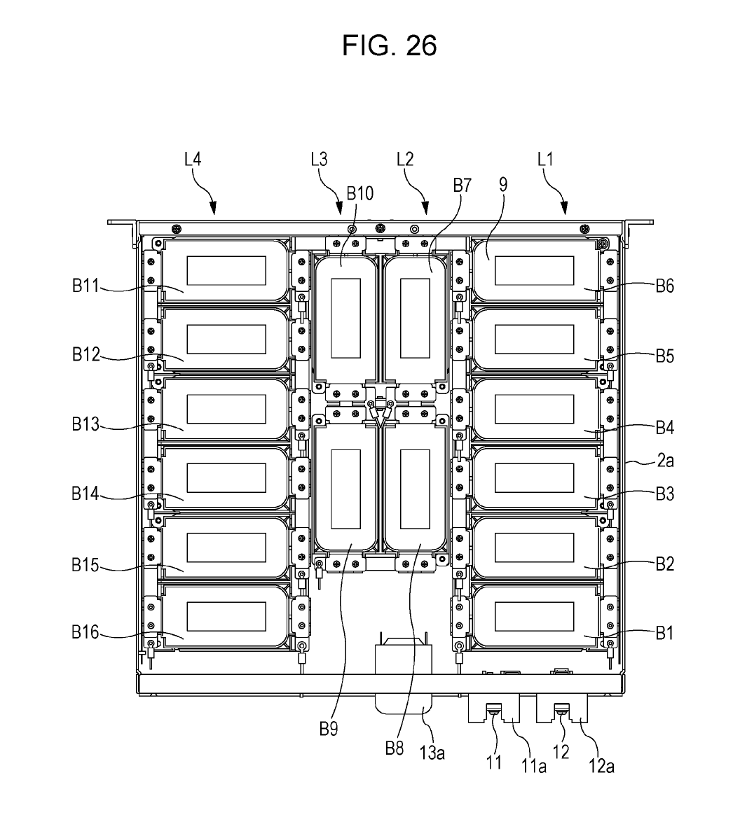

FIG. 26 is a plan view that shows an example of a connection configuration of a plurality of battery blocks accommodated in an exterior lower case. It is desirable that sixteen battery blocks B1 to B16 are arranged in approximately an M shape so as to form four rows. By arranging the battery blocks B1 to B16 in this manner, it is possible to enhance accommodation efficiency of the battery blocks B1 to B16 and the battery 21 within the exterior case 2. Furthermore, it is desirable that sixteen battery blocks B1 to B16 are arranged so that an electrical wiring path thereof forms approximately an M shape. By arranging the battery blocks B1 to B16 so as to have such a wiring path, it is possible to enhance accommodation efficiency of the battery blocks B1 to B16 and the battery 21 within the exterior case 2. In the following description, the four rows are referred to as a first row block L1, a second row block L2, a third row block L3 and a fourth row block L4 from one side wall to the other side wall of the exterior lower case 2a. Herein, a case, where the battery unit 1 includes sixteen battery blocks B1 to B16, will be described as an example, but the number of the battery blocks B is not limited to this example. The battery blocks B of the second row block L2 and the third row block L3 are disposed so as to be shapes in which the battery block B of the first row block L1 is rotated in a horizontal direction by 90° or 270°. The battery block B of the fourth row block L4 is disposed so as to be the same shape as that of the battery block B of the first row block L1 or a shape in which the battery block B of the first row block L1 is rotated 180°.

The first row block L1 includes the battery blocks B1 to B6, and the connection portions 46a and the connection portions 46b provided on both end portions of the battery blocks B1 to B6 are disposed in a linear shape. The second row block L2 includes the battery blocks B7 and B8, and the third row block L3 includes the battery blocks B9 and B10. The connection portions 46a and the connection portions 46b provided on both end portions of the battery blocks B7 and B10 are disposed in a linear shape, and the connection portions 46a and the connection portions 46b provided on both end portions of the battery blocks B8 and B9 are disposed in a linear shape. The fourth row block L4 includes the battery blocks B11 to B16, and the connection portions 46a and the connection portions 46b provided on both end portions of the battery blocks B11 to B16 are disposed in a linear shape.

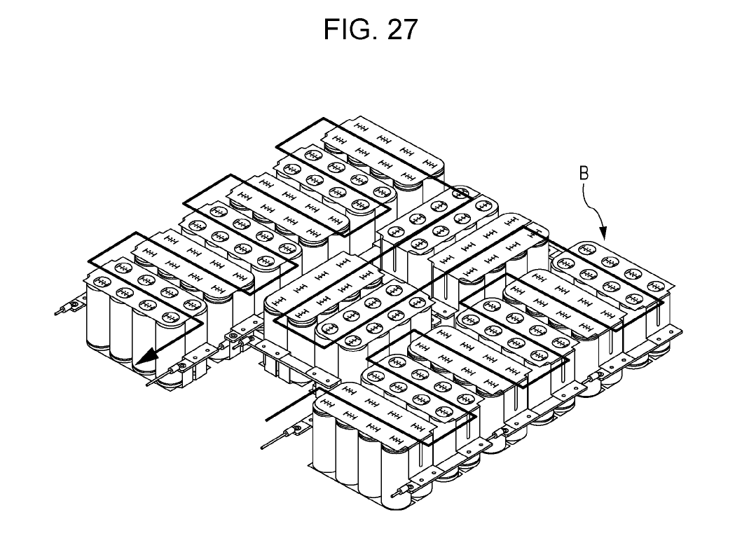

FIG. 27 is a perspective view that shows an example of a connection configuration of a plurality of battery blocks. The battery blocks B1 to B16 are electrically connected in series to a path shown by an arrow in FIG. 27. In addition, the connection configurations of the battery blocks B1 to B16 are not limited to this example, and connection configurations to be electrically connected in parallel may be adopted. In FIGS. 26 and 27, the upper surfaces of the battery blocks B1, B3, B5, B7, B9, B11, B13 and B15 are positive pole surfaces of the battery, and the upper surfaces of the battery blocks B2, B4, B6, B8, B10, B12, B14 and B16 are negative surfaces of the battery. Herein, a configuration of FIG. 27 having a different disposition of the battery blocks will be described. For example, all the upper surfaces of the battery blocks B1 to B16 accommodated in the exterior lower case may be the positive pole surfaces of the battery. In other words, the positive pole terminal surfaces 21a of the batteries of all the battery blocks B may be configured to face the exterior upper case. By disposing the positive pole terminal portion 21a of the battery block B on the upper surface, the gravity of the battery itself is not applied to the positive pole terminal portion 21a of the battery, which makes it possible to further reduce the load of the positive pole terminal portion 21a of the battery 21. Generally, since the pressure blocking mechanism of the battery 21 is provided near the positive pole terminal portion of the battery 21, the lower the load of the positive pole terminal portion 21a of the battery 21 is, the easier it is for the pressure blocking mechanism of the battery 21 to be operated. Furthermore, when the pressure blocking mechanism of the battery 21 is operated and an opening portion is provided in a part of the battery 21, a gap near the positive pole terminal portion 21a of the battery 21 is enlarged, whereby the lower the pressure is, the easier it is for the gas of high pressure in the battery to be discharged to the outside. For this reason, by disposing the positive pole terminals 21a of the batteries 21 of all the battery blocks B on the upper surface, the stability of the battery 21 can be further enhanced.

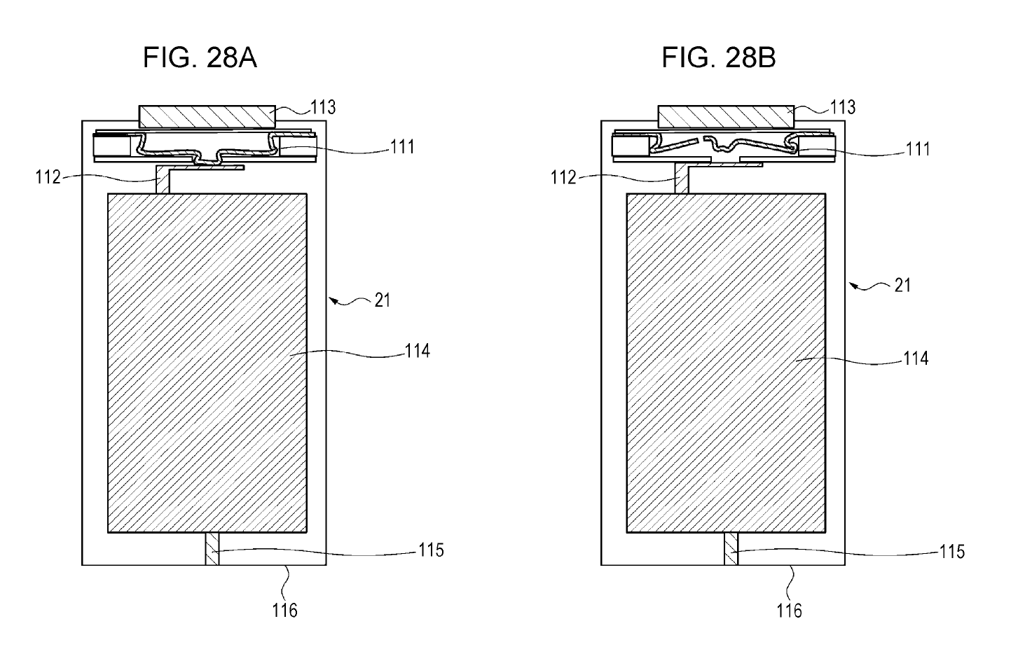

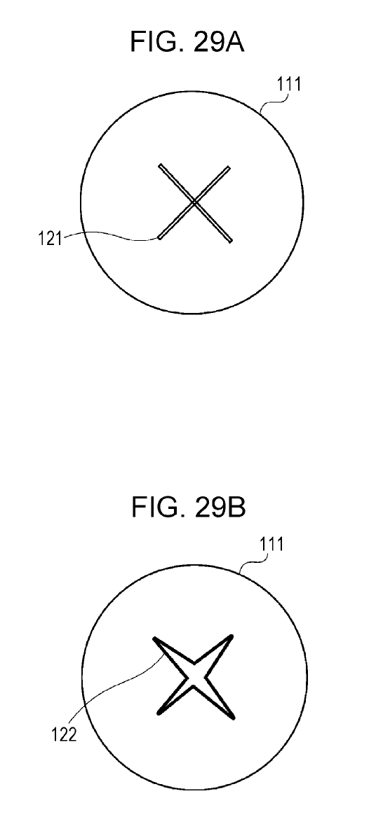

In FIGS. 28A and 28B, a safety valve 111 of a general battery will be described. FIG. 28A shows a case where in the common state, the safety valve 111 is electrically connected to a battery inner positive pole connection plate 112, and in a state in which a crack does not exist in the safety valve 111, the gas in the battery is sealed. FIG. 28B is a state in which, in the blocking state, the safety valve 111 is electrically disconnected from the battery inner positive pole connection plate 112 and an opening portion exists in the safety valve 111, and the gas within the battery can be opened to the outside. FIGS. 29A and 29B are plan views of the safety valve. FIG. 29A is in the common state and a cross-shaped thin portion 121 is provided near the center of the battery 21. FIG. 29B is the blocking state, and an opening portion 122 exists near the center of the battery 21. This shows that the cross-shaped thin portion 121 in FIG. 29A is torn to form the opening portion 122.

The safety valve 111 is disposed near the positive pole of the battery 21 and is a plate of a circular shape for sealing the gas in the battery. The safety valve 111 is electrically connected to the positive pole terminal portion 113 of the battery 21. The safety valve 111 is electrically connected to a battery electricity generation element portion 114. The battery electricity generation element portion 114 includes a current collector of the positive pole, an electrode material of the positive pole, a current collector of the negative pole, an electrode material of the negative pole, an electrolyte or the like. The battery inner positive pole connection plate 112 electrically connects the battery electricity generation element portion 114 with the safety valve 111. A battery inner negative pole connection plate 115 electrically connects the battery electricity generation element portion 114 with the negative pole terminal portion 116 of the battery 21.

There is provided a function in which the battery 21 enters an abnormal state due to factors such as being charged by an excessive voltage or the like, the gas is generated in an inner portion of the battery, and when the pressure of the inner portion of the battery increases, the safety valve 111 is deformed to a convex shape, thereby cutting off the connection of the battery inner positive pole connection plate 112 connected to the battery electricity generation element portion 114 in the battery with the safety valve 111, and the opening portion 122 is generated in the thin portion 121 of the center portion of the safety valve 111, thereby discharging the gas in the battery to the outside. In this manner, the function of cutting off the electric connection in the battery and providing the opening portion in the battery, thereby making it possible to discharge the gas in the battery to the outside is generally defined as a pressure blocking function. Herein, when the load from the upper surface in the vicinity of the positive pole terminal portion 113 of the battery is high, the safety valve is hardly deformed to the convex shape, which makes it possible to disturb the operation of the safety valve.

The configuration of FIG. 27 having the different disposition of the battery block will be described. In a case where the battery 21 has the above-mentioned safety valve 111, for example, all the upper surfaces of the battery blocks B1 to B16 accommodated in the exterior lower case 2a may be the positive pole surfaces of the battery 21. In other words, the positive pole terminal portions 21a of the batteries 21 of all the battery blocks B may face the exterior upper case 2b. In a case where the upper surface of the battery block B is the positive pole terminal portion 21a of the battery 21, the gravity of the battery itself is not applied to the positive pole terminal portion 21a. For this reason, the safety vale 111 is easily deformed to the convex shape. Furthermore, since the pressing force of the upper surface is relatively small, it is possible to easily enlarge the gap between it and the plate, which is in contact with the positive pole terminal portion 21a of the battery 21 via the metallic plate, by the pressure due to the gas discharged from the inner portion of the battery, and thus the gas in the battery is easily discharged to the outside. By setting the upper surfaces of all the battery blocks B as the positive pole terminal portion 21a of the battery 21, when the pressure of the inner portion of the battery 21 increases due to a certain cause, it is possible to make the pressure blocking function of the battery 21 easier to operate. In the case of this configuration, since the pressure blocking function of the battery 21 is easily operated, the stability of the battery 21 can be further enlarged. Meanwhile, when the lower surface of the battery block B is set as the positive pole of the battery 21, since the gravity of the battery itself is applied, the safety valve 111 is hardly operated. Furthermore, since the gap near the positive pole portion of the battery 21 is small, the gas in the battery is hardly discharged in a case where the pressure blocking function is operated. For this reason, there is a possibility in which the stability of the battery further declines at the time of the abnormality of the battery 21.

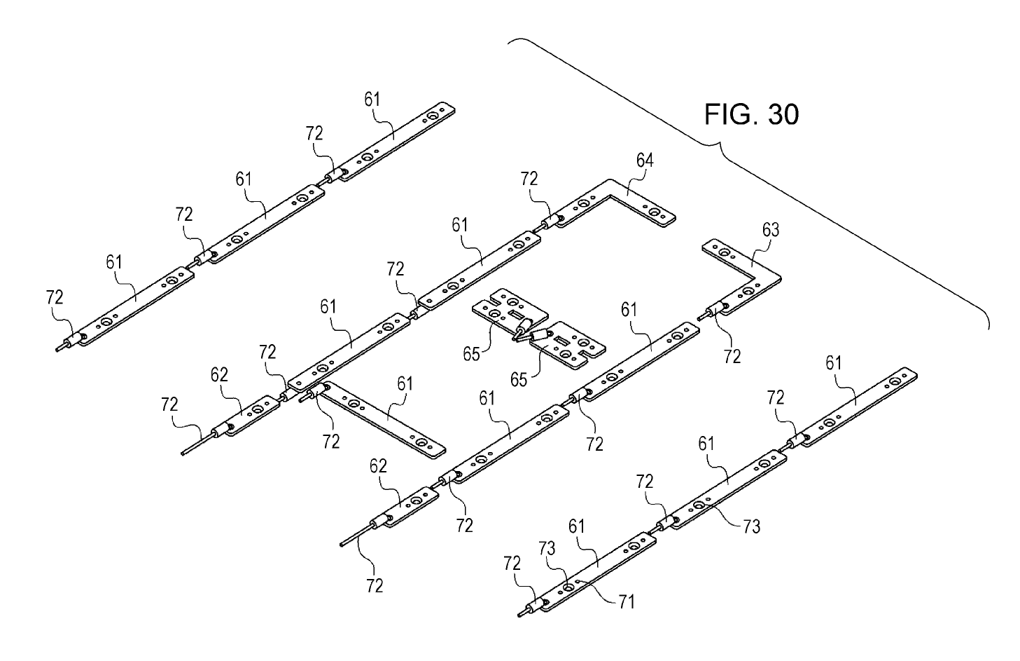

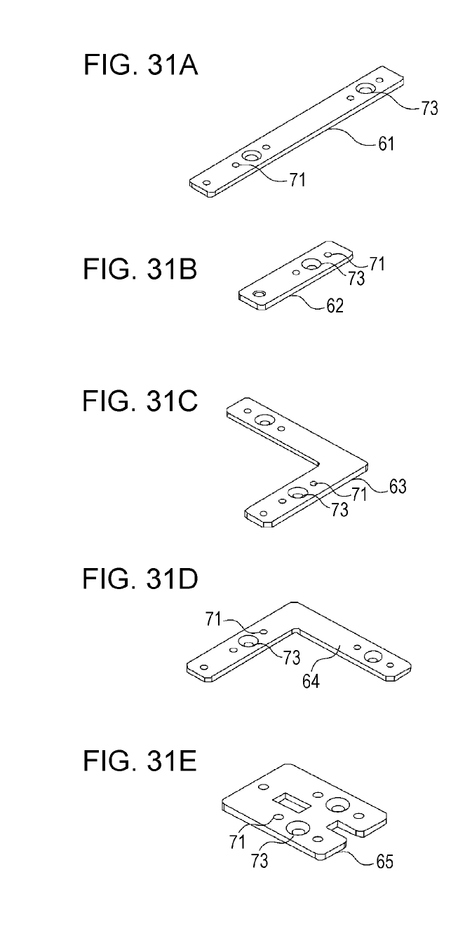

FIG. 30 is a perspective view that shows an example of a disposition configuration of a connection metallic plate. The battery blocks B1 to B16 are connected to each other by a plurality of connection metallic plates 61 to 65 that are connectors. The connection metallic plates 61 to 65 are disposed on the connector attachment portions 52 of the respective battery block restriction portions 4, respectively. One or a plurality of screw holes 71 is provided on the connection metallic plates 61 to 65, respectively, and is connected with the connection portion 46a of the positive pole metallic plate 23a or the connection portion 46b of the negative pole metallic plate 23b by the screw holes 71. Furthermore, in the connection metallic plates 61 to 65, connection portions such as screw holes for connecting an end of a wiring 72 connected to a voltage detection terminal of a measurement control portion are provided, respectively. Furthermore, fitting holes 73 are provided near the screw holes 71 of the connection metallic plates 61 to 65 and the fitting holes 73 may be fitted with respect to protrusion portions provided on the connector attachment portion 52. Furthermore, fitting holes 73 are provided near the screw holes 71 of the connection metallic plates 61 to 65, tapping-machined holes for receiving the screws are provided in the connector attachment portion 52, and screws may be inserted and screwed into the fitting holes 73 and the screw receiving holes of the connector attachment portion 52 while being rotated. As a result, the connection metallic plates 61 to 65 can be positioned and fixed to the connector attachment portion 52. FIGS. 31A to 31E are enlarged views of the connection metallic plates 61 to 65. The screw holes 71 and the fitting holes 73 are provided in the connection metallic plates 61 to 65. By using the connection metallic plate of five types of shapes, the relative positional relationship between two battery blocks B can be freely disposed.

As mentioned above, by arranging the battery blocks B1 to B16 in approximately an M shape and using the connection metallic plates 61 to 65 in the connection, it is possible to perform the supply of electricity of the battery blocks B1 to B16 in a simple structure and at a low resistance. Furthermore, the battery blocks B1 to B16 can be connected by the wiring over a short distance. In addition, the connection of the battery blocks B1 to B16 can use a print wiring substrate without being limited to the connection metallic plates 61 to 65. As a result, the high workability can be obtained, and in a case where the respective connection metallic plates 61 to 65 are connected to the measurement control portion or the like to detect the voltages of the respective battery blocks B, stability can be further improved.

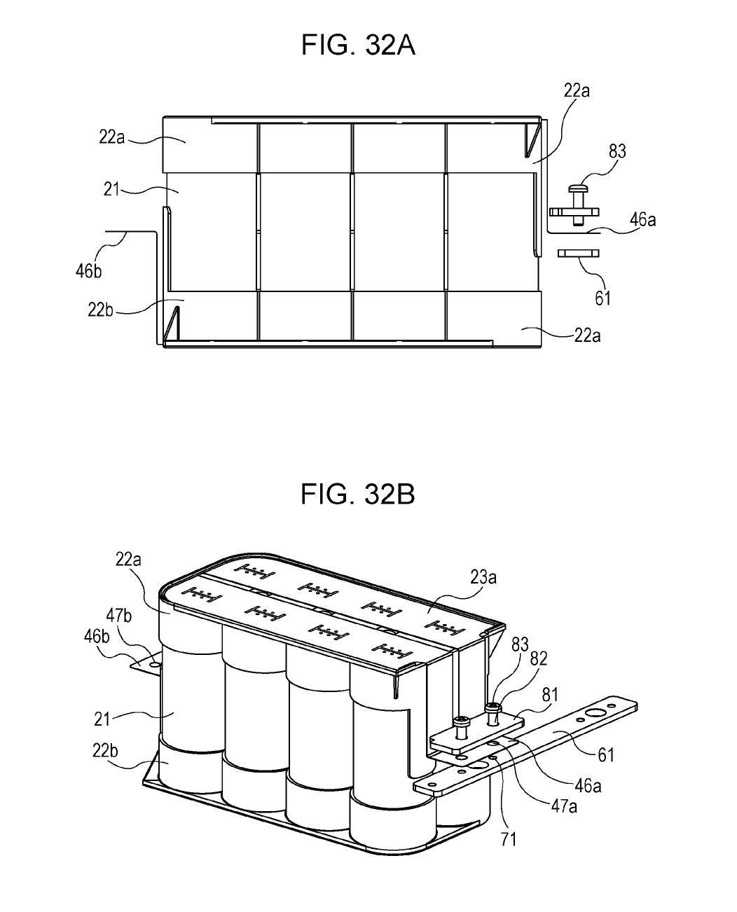

FIG. 32A is a perspective view that shows a battery block connected to the connection metallic plate 61. FIG. 32B is an exploded diagram that shows constitution members used in the connection with the connection metallic plate 61. Between the connection metallic plate 61 and the metallic plate 81, the connection portion 46a of the positive pole metallic plate 23a is disposed. The connection metallic plate 61 has one or a plurality of screw holes 71, and the screw holes are subjected to the tapping-working or the like in order to receive the screws. The metallic plate 81 has one or a plurality of screw holes 82, and the connection portion 46a has one or a plurality of screw holes 47a. One or the plurality of screws 83 is rotated and inserted into the screw holes 82, 47a and 71, is rotated by more than a predetermined torque, and is fastened, whereby the static pressure load is applied to both surfaces of the connection portion 46a. The connection portion 46b has one or a plurality of screw holes 47b. One or the plurality of screws 83 is rotated and inserted into the screw holes 82, 47b and 71, is rotated by more than a predetermined torque, and is fastened, whereby the static pressure load is applied to both surfaces of the connection portion 46b. Similarly to the above-mentioned connection metallic plate 61, the connection metallic plates 61, 62 to 65 are also connected to the connection portion 46a or 46b of the battery block B.

As mentioned above, since the battery blocks B1 to B16 are freely attached to and detached from the connection metallic plates 61 to 65 by the screw 83, the connection metallic plates 61 to 65 can be easily exchanged for new battery blocks B1 to B16. Furthermore, by the fastening torque of the screw 83, since the connection metallic plates 61 to 65 can be brought into contact with the connection portion 46a or the connection portion 46b in the wide area and at a strong static pressure load, long-term reliability can be improved. Furthermore, when plate thicknesses of the connection metallic plates 61 to 65 are equal to or greater than 1 mm, the resistance between the battery blocks can be equal to or lower than about 5 mΩ. Moreover, when the static pressure load is applied to the connection portion 46a or the connection portion 46b by the connection metallic plates 61 to 65 and the metallic plate 81 and the connection metallic plates 61 to 65 and the metallic plate 81 are brought into close-contact with each other in an area equal to or more than 1 cm2, the connection resistance between the connection portion 46a or the connection 46b and the connection metallic plates 61 to 65 can be equal to or less than about 1 mΩ.

Circuit Configuration of Battery Unit

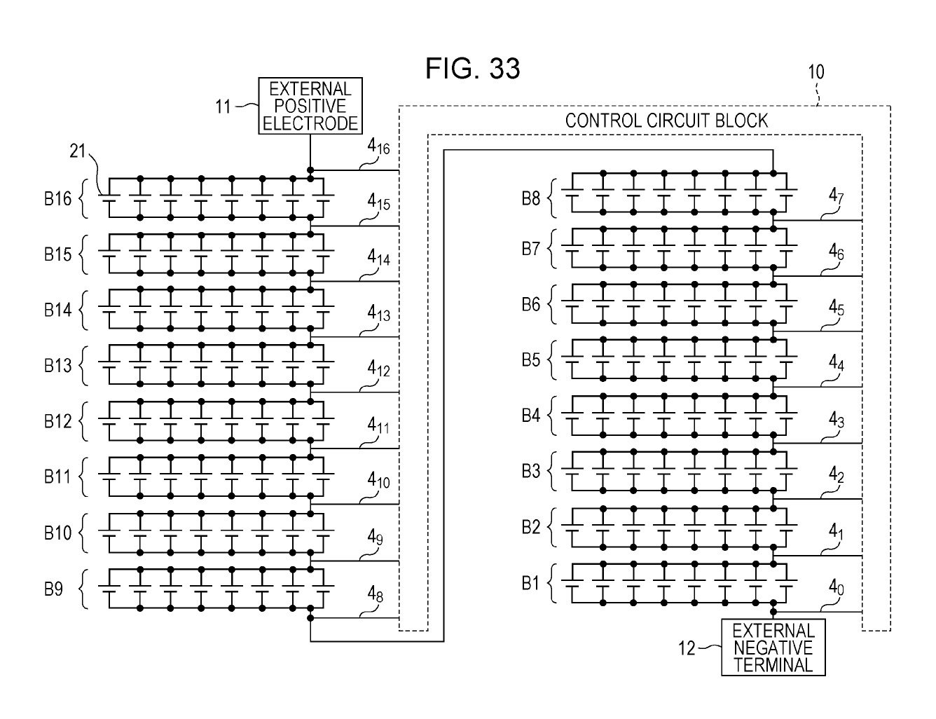

FIG. 33 is a circuit diagram that shows a connection circuit diagram of a battery unit according to an embodiment of the present application. In the battery unit according to the present embodiment, for example, the battery block B, in which eight secondary batteries 21 are connected in parallel to each other, is used. Moreover, the battery blocks B1 to B16 (hereinafter, in the case of showing all the battery blocks B, suitably referred to as battery block B) of sixteen blocks are connected in series to each other. In other words, sixteen battery blocks B including eight secondary batteries 21 electrically connected in parallel to each other are electrically connected in series to each other. The battery blocks B1 to B16 are connected to the control circuit block 10, respectively, and the charging and the discharging thereof are controlled. Furthermore, the charging and the discharging are performed via the external positive pole terminal 11 and the external negative pole terminal 12.

### First Configuration Example

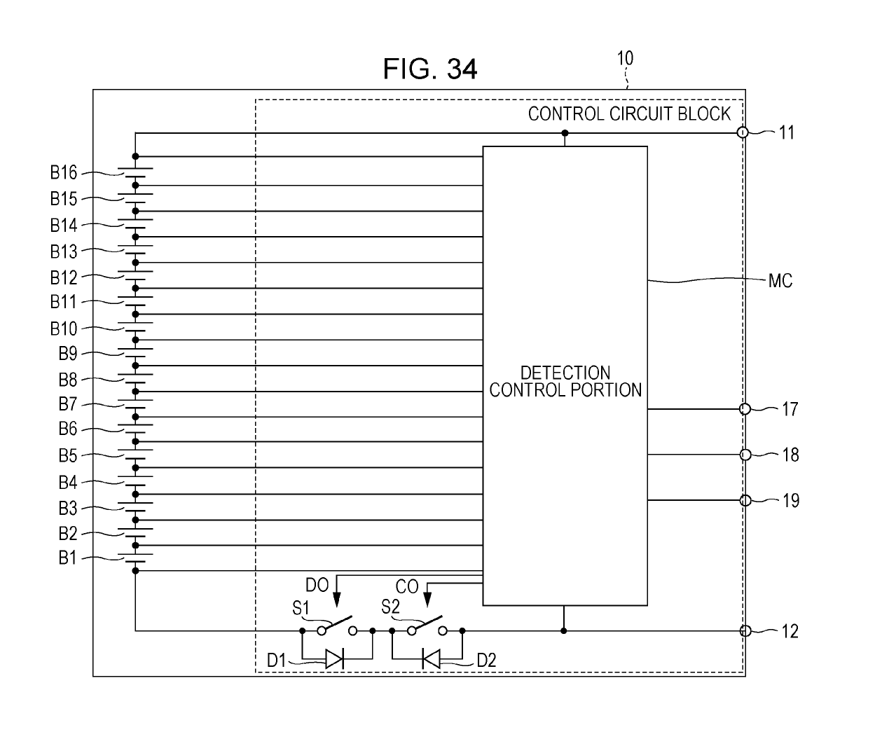

FIG. 34 is a circuit diagram that shows a first configuration example of a battery unit according to an embodiment of the present application. The battery unit includes the battery blocks B1 to B16, the control circuit block 10, external positive pole terminal 11, the external negative pole terminal 12, a communication terminal 17, an overcharge signal terminal 18, and an over discharge signal terminal 19.

The external positive pole terminal 11 and the external negative pole terminal 12 are connected to an external control unit or the like, and the charging and the discharging relative to the battery unit are controlled via the control unit. Similarly, the communication terminal 17, the overcharge signal terminal 18 and the over discharge signal terminal 19 are also connected to the external control unit, whereby the transmission and reception of various signals are performed between the battery unit and the control unit via the terminals.

The control circuit block 10 includes a measurement control portion MC and a switch that can block the charging current and the discharging current of the battery. The switch includes a switch S1 for performing the control of the discharging current, and a switch S2 for performing the control of the charging current.

The switch S1 and the switch S2 include a diode D1 and a diode D2, respectively. The diode D1 included in the switch S1 for performing the control of the discharging current has a polarity of an opposite direction to the discharging current flowing from the external negative pole terminal 12 in the direction of the battery block B in a forward direction with respect to the charging current flowing in the direction of the battery block B form the external positive pole terminal 11. Meanwhile, the diode D2 included in the switch S2 for performing the control of the charging current has a polarity of an opposite direction to the charging current and a forward direction to the discharging current.

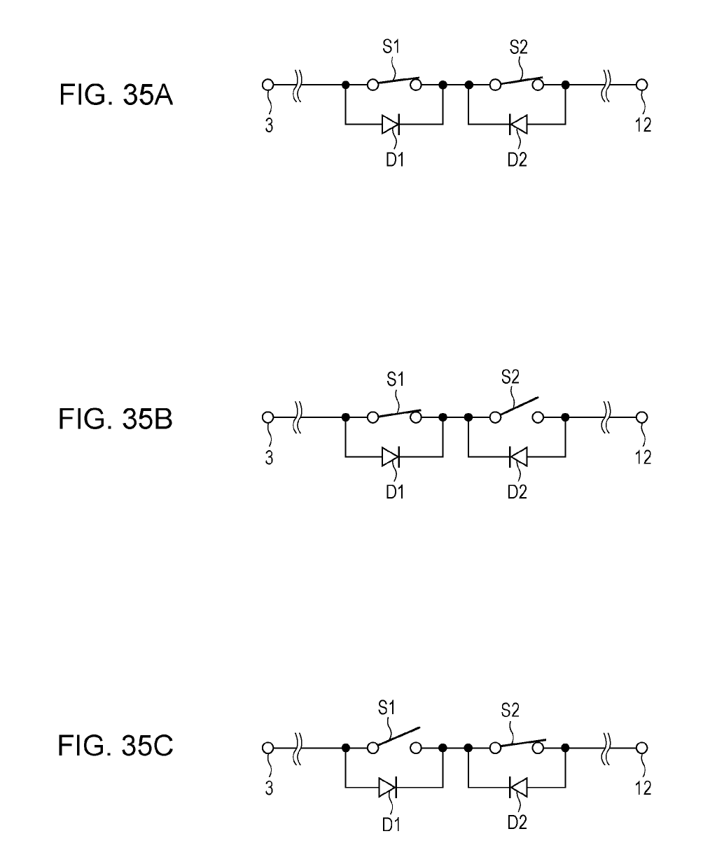

FIGS. 35A to 35C shows a state of the switch S1 and the switch S2 upon controlling the charge and the discharge. In addition, FIG. 35A shows a state in which the charge and the discharge are possible. FIG. 35B shows a state in which the charge is prohibited and only the discharge is possible. FIG. 35C shows a state in which only the charge is possible and the discharge is prohibited.

As shown in FIG. 35A, when both of the charge and the discharge are possible, both of the switch S1 and the switch S2 enter the connection state. When the charge is prohibited, as shown in FIG. 35B, the switch S1 enters the connection state and the switch S2 enters the open state. At this time, the switch S2 is in the open state, but it is possible to cause the discharging current to flow via the diode D2. Thus, all the switches enter a state in which only the discharge is possible.

On the other hand, when the discharge is prohibited, as shown in FIG. 35C, the switch S1 enters the open state and the switch S2 enters the connection state. At this time, the switch S1 enters the open state, but it is possible to cause the charging current to flow via the diode D1. Thus, all the switches enter the state in which only the charge is possible.

The measurement control portion MC observes the current and the voltage of the battery blocks B1 to B16 and transmits the control signal for controlling the charge and discharge control depending on the detected voltage to the switch S1 and the switch S2.

Common state→Overcharge State

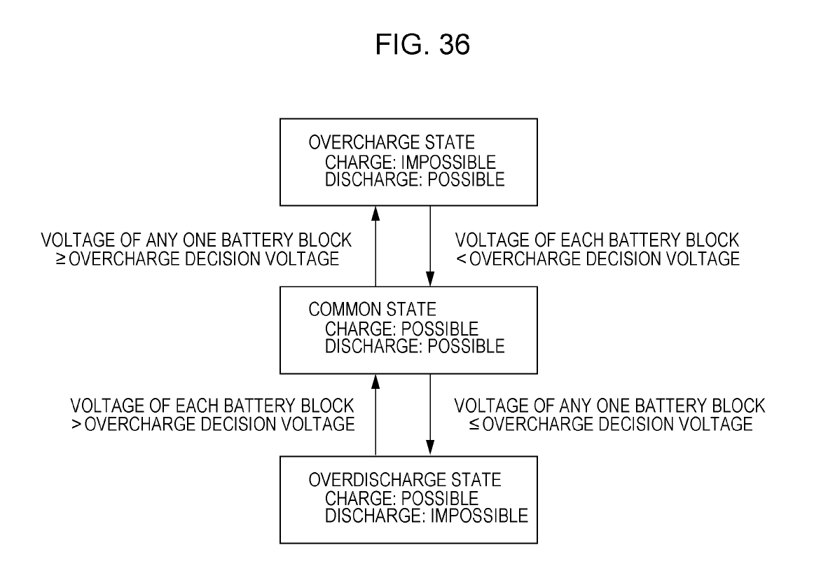

For example, as shown in FIG. 36, in the case of the common state in which the charge and the discharge are possible, respectively, when it is detected that the voltage of any one of the battery blocks B1 to B16 is equal to or greater than a predetermined overcharge determination pressure, it is determined that any one of the battery blocks B1 to B16 is in the overcharge state. In the case of shifting from the common state to the overcharge state, a control signal CO for controlling the switch S2 to the open state is transmitted to the switch S2 so that the charge is not possible, so that the charging current does not flow. Meanwhile, a control signal DO for controlling the switch S1 to the connection state is consecutively transmitted to the switch S1 so that the discharge is still possible even in the case of being shifted to the overcharge state. As a result, a state is maintained in which the discharging current can consecutively flow. In the overcharge state, the measurement control portion MC controls the switch S1 and the switch S2 so that the switch S1 and the switch S2 enter the state of FIG. 35B.

Overcharge State→Common State

When the battery is in the overcharge state, in a case where it is detected that all the voltages of the battery blocks B1 to B16 are lower than the overcharge determination voltage, the battery returns to the common state. Upon returning to the common state, the battery is controlled in a state in which both of the charge and the discharge are possible. For this reason, the control signal CO is transmitted to the switch S2 of the open state, thereby controlling the switch S2 to the connection state. A control signal DO for consecutively controlling the switch S1 to the connection state is consecutively transmitted to the switch S1. In the common state, the measurement control portion MC controls the switch S1 and the switch S2 so that the switch S1 and the switch S2 enter the state of FIG. 35A.

Common State→Over Discharge State

When the battery is in the common state, in case where it is detected that the voltage of any one of the battery blocks B1 to B16 is equal to or less than a predetermined over discharge determination voltage, it is determined that any one of the battery blocks B1 to B16 enters the over discharge state. In the case of shifting from the common state to the over discharge state, a control signal DO for controlling the switch S1 to the open state is transmitted to the switch S1 so that the discharge is not possible, so that the discharging current does not flow. Meanwhile, the control signal CO for controlling the switch S2 to the connection state is consecutively transmitted to the switch S2 so that the charge is still possible even in the case of shifting to the over discharge state. As a result, a state is maintained in which the charging current can consecutively flow. In the over discharge state, the measurement control portion MC controls the switch S1 and the switch S2 so that the switch S1 and the switch S2 enter the state of FIG. 35C.

Over Discharge State→Common State

When the battery is in the over discharge state, in a case where it is detected that all the voltages of the battery blocks B1 to B16 are higher than the overcharge determination voltage, the battery returns to the common state. Upon returning to the common state, the battery is controlled in a state in which both of the charge and the discharge are possible. For this reason, the control signal DO is transmitted to the switch S1 of the open state, thereby controlling the switch S1 to the connection state. A control signal CO for consecutively controlling the switch S2 to the connection state is consecutively transmitted to the switch S2. In the common state, the measurement control portion MC controls the switch S1 and the switch S2 so that the switch S1 and the switch S2 enter the state of FIG. 35A.

Example of Switch Specific Configuration

As the switch S1 and the switch S2, for example, an N type FET (Field Effect Transistor) can be used.

In the case of using the N type FET, the switch S1 and the switch S2 is provided between the battery block B and the external negative pole terminal 12. Furthermore, the diode D1 and the diode D2 are provided between the respective drain sources of the switch S1 and the switch S2.

The control signals DO and CO from the measurement control portion MC are supplied to the respective gate terminals of the switch S1 and the switch S2. In the common state, the control signal DO becomes a logic “H” level (hereinafter, referred to as a high level) and the switch S1 enters the connection state. Furthermore, similarly, the control signal CO also becomes the high level and the switch S2 enters the connection state. In the case of using an N channel type of FET as the switch S1 and the switch S2, the switch S1 and the switch S2 enter the connection state by applying the voltage equal to or greater than a predetermined value to the gate terminal of FET. Herein, the voltage applied to the gate terminal of the FET is a voltage value which sets the source terminal of the FET to the electric potential of zero V. That is, in the usual charge and discharge operations, the control signals DO and CO become the high level, and the switch S1 and the switch S2 enter the connection state. For example, by applying the voltage of about 4V or more to the gate terminal of the FET, the switch S1 and the switch S2 enter the connection state. For example, by applying the voltage of about 1V or less to the gate terminal of the FET, the switch S1 and the switch S2 enter the open state.

On the other hand, when the control signals DO and CO become a low level, the switch S1 and the switch S2 enter the open state. In a case where the control signal DO to the switch S1 become the low level and only the switch S1 is controlled to be in the open state, only the charge via the diode D1 is possible. In a case where the control signal CO to the switch S2 become the low level and only the switch S2 is controlled to be in the open state, only the discharge via the diode D2 is possible.

As the switch S1 and the switch S2, for example, a P type of FET can be used. In this case, the switch S1 and the switch S2 are provided at a high electric potential side which is close to the external positive pole terminal 11. In the case of using a P channel type of FET as the switch S1 and the switch S2, the switch S1 and the switch S2 are controlled to be in the connection state by applying the voltage equal to or greater than a predetermined value to the gate terminal of FET. Herein, the voltage applied to the gate terminal of the FET is a voltage value which sets the source terminal of the FET to the electric potential of zero V. That is, in the usual charge and discharge operations, the control signals DO and CO become the low level, and the switch S1 and the switch S2 enter the connection state. Meanwhile, in a case where any one of the switch S1 and the switch S2 is controlled to be in the open state, the control signals DO and CO from the measurement control portion MC supplied to the gate of any one of the switch S1 and the switch S2 are set to the high level, and the switch S1 and the switch S2 are controlled to be in the open state.

Observation and Control of Current

The measurement control portion MC may observe not only the voltage of the battery blocks B1 to B16, but also the current flowing in the battery blocks B1 to B16. In the measurement control portion MC, in a case where it is detected that an excessive current flows at the time of discharging, it is determined to be in a discharging over current state and the control signal is transmitted to the switch S1 so as to control the switch S1 to the open state. Meanwhile, in the measurement control portion MC, in a case where it is detected that an excessive current flows at the time of the charging, it is determined to be in a charging over current state and the control signal is transmitted to the switch S2 so as to control the switch S2 to the open state. As a result, it is possible to prevent an excessive current from flowing at the time of a short circuit and thereby damaging the respective secondary batteries 21 of the battery blocks B1 to B16. Furthermore, it is possible to prevent the components in the circuit from being damaged.

### Second Configuration Example

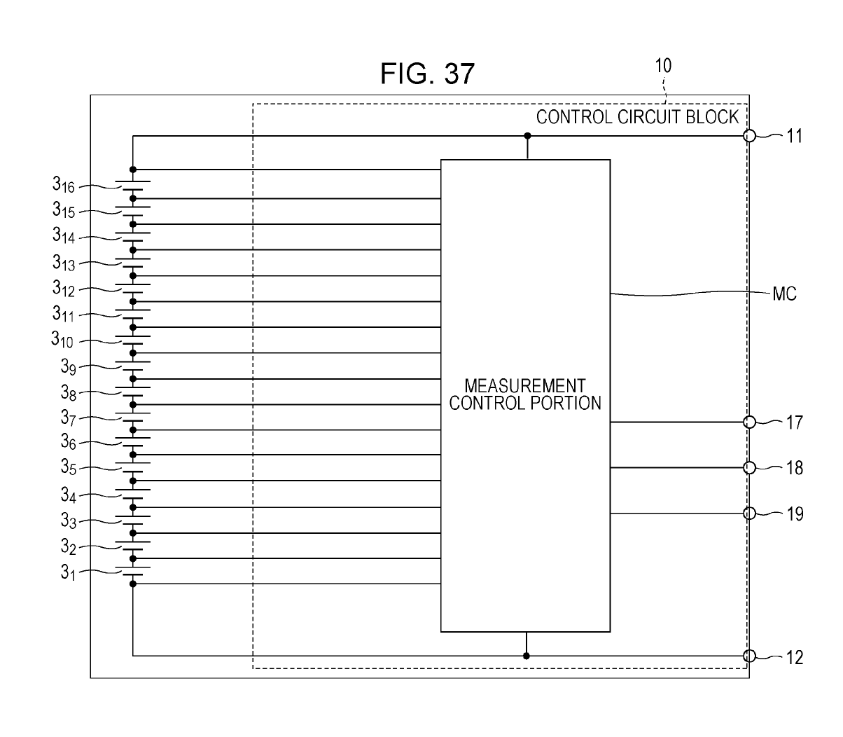

FIG. 37 shows a second circuit configuration of a battery of the present application. The second circuit configuration is different from the first configuration example in that the switch S1 and the switch S2 are not provided. In the second circuit configuration, the measurement control portion MC decides the states of the battery blocks B1 to B16 based on the voltage measured in the measurement control portion MC, and, when it is determined to be in the overcharge state, the measurement control portion MC notifies the control unit of the overcharge state via the overcharge signal terminal 18. When the measurement control portion MC decides that the states of the battery blocks B1 to B16 are in the over discharge state, the measurement control portion MC notifies the control unit of the overcharge state via the over discharge signal terminal 19. In the case of using the battery of the second circuit configuration, the protection circuit of the control unit is configured so that the control of the charging and the discharging are performed in the control unit side.

### Third Configuration Example

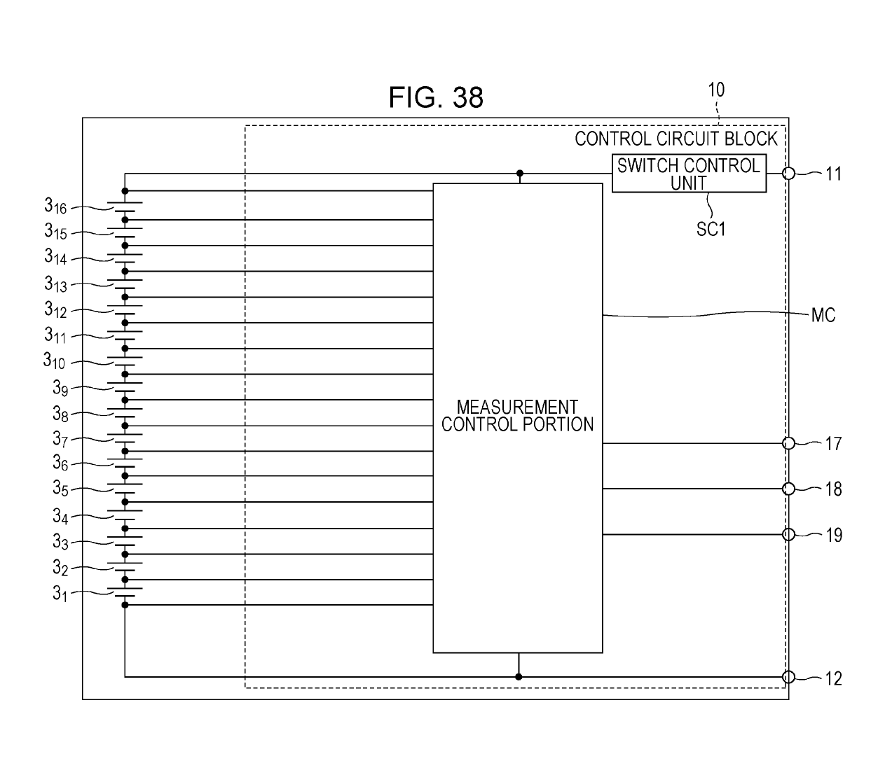

FIG. 38 shows a third circuit configuration of a battery of the present application. The third circuit configuration is different from the first configuration example in that the switch S1 and the switch S2 are not provided and a switch control portion SC1 is provided in a high electric potential side adjacent to the external positive pole terminal 11. The switch control portion SC1 is connected between the positive pole terminal of the uppermost battery block and the external positive pole terminal 11. The switch control portion SC1 controls whether or not the electric current application of both the charging current and the discharging current is performed. The switch control portion SC1 can switch over the electric current application state and the release state of both sides of the charging current and the discharging current by the lever operation due to the manual working of a worker. The switch control portion SC1 is, for example, a breaker. When the switch control portion SC1 is in the electric current application, the charging current and the discharging current can flow. When the switch control portion SC1 is in the release state, it is difficult to cause the charging current and the discharging current to flow.

As mentioned above, according to one embodiment, since the connection portions 46a and 46b of the respective battery blocks B are connected in series or in parallel by the connection metallic plates 61 to 65, the connection electric resistance can be reduced. Furthermore, since the battery blocks B are configured so as to be freely attached to and detached from the battery block restriction portion, the exchange of the battery block B can be easily performed. Furthermore, since the connection portions 46a and 46b disposed on both side surfaces of the battery block B are electrically connected by the connection metallic plates 61 to 65, the cooling efficiency of the connection path can be improved.

### Modified Example

### Modified Example of Battery Unit

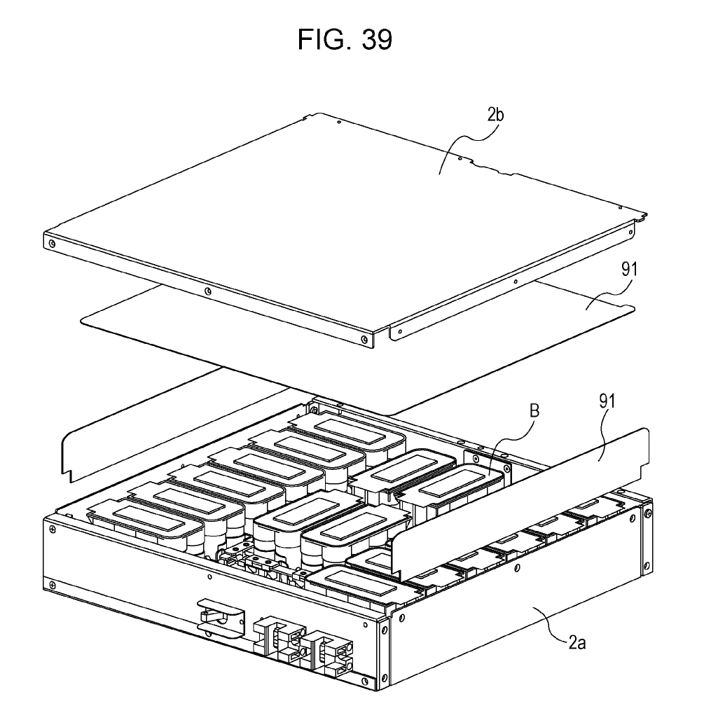

FIG. 39 shows a modified example of a battery unit. As shown in FIG. 39, it is desirable to dispose an insulating material 91 such as a resin plate between the exterior upper case 2b and/or the exterior lower case 2a and the plurality of battery blocks B. As a result, since the battery block B can be made as a structure having the high insulating property, the stability can be improved. As a shape of the insulating material, for example, a plate shape or sheet shape can be adopted, but the shape of the insulating material may be a shape that can insulate the battery block B and the exterior upper case 2b and/or the exterior lower case 2a, and the shape is not particularly limited to these shapes.

For example, the insulating material 91 may be a shock absorbing material having an elastic function in which the thickness thereof is deformed by the pressure. For example, the insulating material 91 may be rubber. For example, the insulating material 91 may be a plate having a plurality of bubbles. For example, the insulating material 91 may be a heat transfer material having heat conductivity. For example, the insulating material 91 may be a heat conductive material that contains metallic powder or carbon and has high heat conductivity. As a result, the heat generated by the battery 21 can be further effectively radiated to the outside. For example, the insulating material 91 may have a configuration in which a heat conductive material having excellent heat conductivity is combined with the shock absorbing material having excellent elasticity. For example, the insulating material 91 may have a plate thickness of 1 mm or more. For example, the insulating material 91 may be an integral shape which covers all the upper surfaces, the lower surfaces, the right side surfaces, the left side surfaces, the front side surfaces and the rear side surfaces of the plurality of battery blocks. For example, the insulating material 91 may be a shape in which an opening portion is provided in a part thereof.

Modified Example of Battery Block

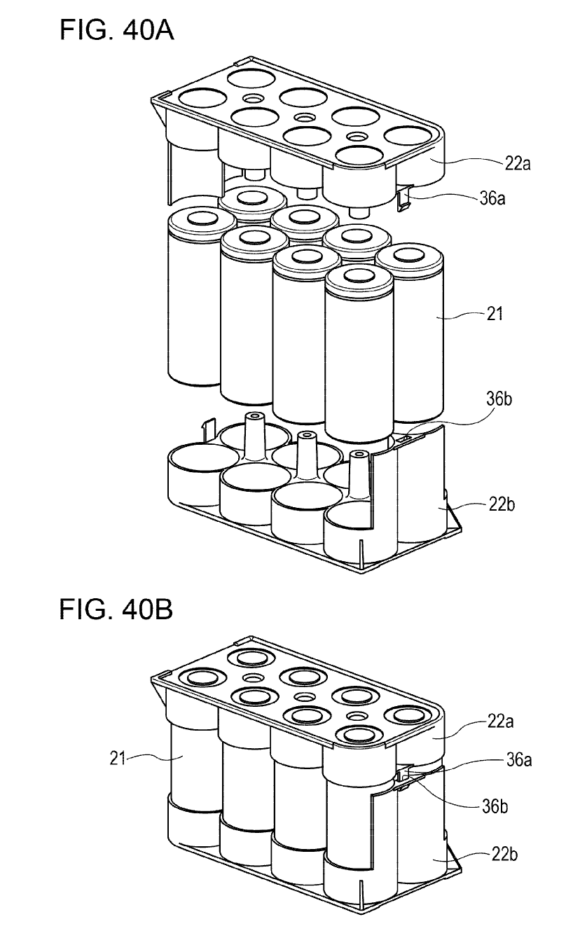

FIGS. 40A and 40B show a first modified example of the battery block. A hook portion 36a may be provided in one part of the battery holders 22a and 22b and a hole portion 36b may be provided the other part thereof, and the hook portion 36a may be fitted to the hole portion 36b, thereby engaging the battery holder 22a and the battery holder 22b with each other.

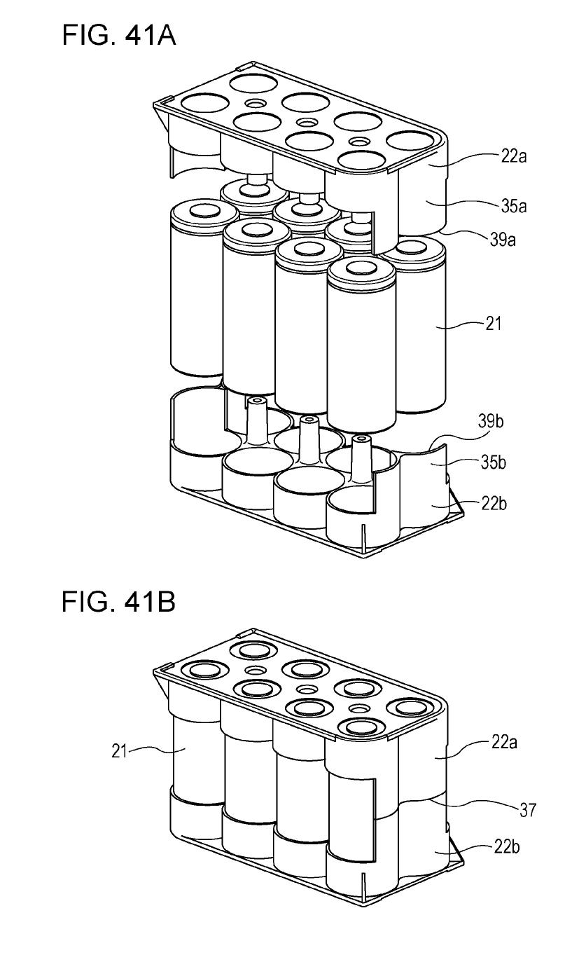

FIGS. 41A and 41B show a second modified example of the battery block. A front end portion 39a of a wall portion 35a of the battery holder 22a may be brought into contact with a front end portion 39b of a wall portion 35b of the battery holder 22b, and the contact portion 37 may be joined by ultrasonic wave welding or the like. Furthermore, an adhesive may be applied to the insides of the battery holder 22a and the battery holder 22b, thereby bonding the battery holder 22b and the battery holder 22a and the battery 21.

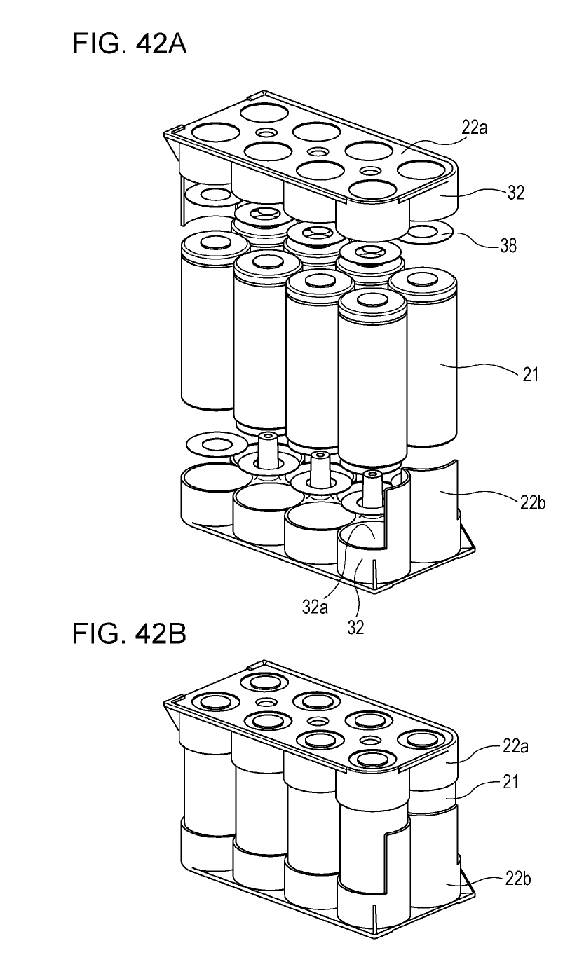

FIGS. 42A and 42B show a third modified example of a battery block. An adhesive material 38 may be disposed in a hole portion 32a included in a fixing portion 32 of the battery holder 22a and the battery holder 22b, thereby bonding both end portions of the battery 21 to the hole portion 32a via the adhesive member 38. It is desirable that a shape of the adhesive material 38 is a shape such as a ring shape having an opening portion in the middle thereof. In this manner, by the shape having the opening portion, it is possible to electrically connect both terminal portions of the battery 21 with the positive pole metallic plate 23a or the negative pole metallic plate 23b via the opening portion. The adhesive member 38 is, for example, an adhesion member such as a double-sided tape having the adhesion property on both sides.

By adopting the above-mentioned configuration, the battery holders 22a and 22b can be fixed to both end portions of the battery 21.

The present disclosure is not limited to the example embodiments described above, and can be modified without departing from the gist of the present disclosure.

For example, the configurations, the methods, the shapes, the materials, the numerical values or the like adopted in the above-mentioned embodiments are merely examples, and the configurations, the methods, the shapes, the materials, the numerical values or the like different from those may be used as necessary.

Furthermore, the respective configurations of the above-mentioned embodiments can be combined with each other unless departing from the gist of the present application.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A battery unit comprising:
a battery case; and
a plurality of battery blocks stored in the battery case, the plurality of battery blocks electrically connected in series, wherein:
(a) a first plurality of the battery blocks form a first column, the first plurality of the battery blocks in the first column being arranged in a side-to-side configuration;
(b) a second plurality of the battery blocks form a second column, the second plurality of the battery blocks in the second column being arranged in an end-to-end configuration which is different from the side-to-side configuration; and
(c) the first column is electrically connected in series to the second column.

2. The battery unit of claim 1, wherein each of the plurality of battery blocks stored in the battery case comprise:
(a) a plurality of batteries connected in parallel, each battery having a positive terminal end and a negative terminal end;
(b) a positive terminal battery holder for securing the positive terminal end of each of the plurality of batteries such that the plurality of batteries are arranged in a predetermined configuration;
(c) a negative terminal battery holder for securing the negative terminal end of each of the plurality of batteries such that the plurality of batteries are arranged in the predetermined configuration;
(d) a positive pole metallic plate including positive terminal contact portions which are electrically connected to the positive terminal ends of the plurality of batteries, the positive terminal contact portions being arranged in predetermined positions based on the plurality of batteries being arranged in the predetermined configuration; and
(e) a negative pole metallic plate including negative terminal contact portions which are electrically connected to the negative terminal ends of the plurality of batteries, the negative terminal contact portions being arranged in predetermined positions based on the plurality of batteries being arranged in the predetermined configuration.

3. The battery unit of claim 2, wherein the battery case comprises at least one battery block restriction portion which restricts a position of at least one of the plurality of battery blocks stored in the battery case.

4. The battery unit of claim 3, wherein the battery block restriction portion restricts a position of a first one of the plurality of battery blocks relative to a position of a second one of the plurality of battery blocks such that a positive pole connection portion of the positive pole metallic plate of the first one of the plurality of battery blocks is positionally fixed relative to a negative pole connection portion of the negative pole metallic plate of the second one of the plurality of battery blocks.

5. The battery unit of claim 1, wherein the battery case comprises at least one battery block restriction portion which restricts a position of at least one of the plurality of battery blocks stored in the battery case.

6. The battery unit of claim 1, wherein the plurality of battery blocks stored in the battery case are positioned within the battery case such that the plurality of battery blocks form approximately an M-shape.

7. The battery unit of claim 5, wherein a current flows through the plurality of battery blocks stored in the battery case, the current flow following approximately an M-shaped path which is governed by the approximate M-shape formed by the positioning of the plurality of battery blocks stored in the battery case.

8. An electrically conductive terminal for electrically connecting a plurality of batteries in parallel, the electrically conductive terminal comprising:
a base plate comprising:
(a) a terminal connection portion oriented in a first plane, the terminal connection portion including a plurality of battery terminal contact portions arranged in a plurality of columns such that the plurality of batteries are connected in parallel;
(b) a lead-out portion oriented in a second plane which is different from the first plane; and
(c) a connection portion oriented in a third plane which is different from the second plane.

9. The electrically conductive terminal of claim 8, wherein each of the battery terminal contact portions include at least one convex shape portion.

10. The electrically conductive terminal of claim 8, wherein the lead-out portion is comprised of a first portion and a second portion, the first portion being oriented substantially perpendicular to the terminal connection portion and the second portion being oriented substantially parallel to the terminal connection portion.

11. A battery block comprising:
a plurality of batteries connected in parallel, each battery having a positive terminal end and a negative terminal end;
a positive terminal battery holder for securing the positive terminal end of each of the plurality of batteries such that the plurality of batteries are arranged in a predetermined configuration;
a negative terminal battery holder for securing the negative terminal end of each of the plurality of batteries such that the plurality of batteries are arranged in the predetermined configuration;
a positive pole metallic plate including positive terminal contact portions which are electrically connected to the positive terminal ends of the plurality of batteries, the positive terminal contact portions being arranged in predetermined positions based on the plurality of batteries being arranged in the predetermined configuration; and
a negative pole metallic plate including negative terminal contact portions which are electrically connected to the negative terminal ends of the plurality of batteries, the negative terminal contact portions being arranged in predetermined positions based on the plurality of batteries being arranged in the predetermined configuration.

12. The battery block of claim 11, wherein the positive pole metallic plate and the negative pole metallic plate have a different shape relative to one another.

13. The battery block of claim 11, wherein the positive terminal battery holder and the negative terminal battery holder have a different shape relative to one another.

14. The battery block of claim 11, wherein the positive terminal battery holder and the negative terminal battery holder each comprise a plurality of voids such that the negative pole metallic plate contacts the negative terminal end of each of the plurality of batteries and such that the positive pole metallic plate contacts the positive terminal end of each of the plurality of batteries.

15. The battery block of claim 11, wherein the positive terminal battery holder and the negative terminal battery holder each comprise a plurality of fixing portions which fix the positions of the plurality of batteries relative to one another.

16. The battery block of claim 11, wherein the positive terminal battery holder and the negative terminal battery holder each comprise a metallic plate disposition surface, the metallic plate disposition surface on the positive terminal battery holder being configured to accommodate the positive pole metallic plate and the metallic plate disposition surface on the negative terminal battery holder being configured to accommodate the negative pole metallic plate.

17. A battery unit comprising:
a battery case; and
a plurality of battery blocks stored in the battery case, the plurality of battery blocks electrically connected together, wherein:
(a) a connection metal electrically connects together adjoining battery blocks of the plurality of battery blocks;
(b) each of the battery blocks include:
(i) a positive pole plate having a lead out portion which is disposed on a first side surface of the battery block; and
(ii) a negative pole plate having a lead out portion which is disposed on a second side surface of the battery block; and
(c) the positive pole plate lead out portion and the negative pole plate lead out portion of adjoining battery blocks are electrically connected together by the connection metal.
